(19) United States
(12) Patent Application Publication
(10) Pub. No.: US 2023/0104838 A1
(43) Pub. Date: Apr. 6, 2023

(54) SYSTEMS AND METHODS FOR PROVIDING FLUID LIGHTENERS WHILE REDUCING DOWNHOLE EMULSIFICATIONS

(71) Applicant: Horizon Mud Company, Inc., Midland, TX (US)

(72) Inventors: Luke Blackwell, Midland, TX (US); Michael McGraw, Midland, TX (US); Tony Farish, Midland, TX (US); Ronnie Farish, Midland, TX (US)

(21) Appl. No.: 18/078,878

(22) Filed: Dec. 9, 2022

Related U.S. Application Data
(63) Continuation-in-part of application No. 17/401,227, filed on Aug. 12, 2021, now Pat. No. 11,542,817.
Application No. 17/401,227 is a continuation of application No. 17/230,559, filed on Apr. 14, 2021.
Application No. 17/230,559 is a continuation-in-part of application No. 17/127,814, filed on Dec. 18, 2020, now abandoned.
(60) Provisional application No. 63/288,292, filed on Dec. 10, 2021.
(60) Provisional application No. 63/295,092, filed on Dec. 30, 2021.
(60) Provisional application No. 62/923,186, filed on Oct. 18, 2019.

(51) Int. Cl. E21B 49/08; E21B 21/00; E21B 21/08

(52) U.S. Cl. CPC E21B 49/088; E21B 21/001; E21B 49/0875; E21B 21/08

(57) ABSTRACT

Various embodiments provide methods and systems for providing sustainable and environmentally friendly fluid lighteners for use in downhole wells. The sustainable and environmentally friendly fluid lighteners may include one or more viscosifiers, one or more aphron generators, and a location-specific non-emulsifying or de-emulsifying surfactant. Various embodiments provide methods and systems for providing continuity of chemistry in downhole wells.

### CROSS-REFERENCE TO RELATED APPLICATIONS

This patent application is a continuation-in-part of U.S. patent application Ser. No. 17/401,227, filed Aug. 12, 2021, which is a continuation of U.S. patent application Ser. No. 17/230,559, filed Apr. 14, 2021, which is a continuation-in-part of U.S. patent application Ser. No. 17/127,814, filed Dec. 18, 2020, which claims priority to U.S. Provisional Patent Application Ser. No. 62/923,186, filed Oct. 18, 2019, all of which are hereby incorporated herein by reference. This patent application claims priority to U.S. Provisional Patent Application Ser. Nos. 63/288,292, filed Dec. 10, 2021, and 63/295,092, filed Dec. 30, 2021, both of which are hereby incorporated herein by reference.

### BACKGROUND

### Technical Field

This invention relates generally to systems and methods for providing chemicals used in downhole operations, such as fluid lighteners and, more particularly, to systems and methods for providing continuity of chemistry, for example using aphrons, in drilling, servicing, drill outs, cleanouts, and other operations related to oil and gas wells.

### Background

An oil well is a general term for any boring through the earth's surface that is designed to find and acquire petroleum oil hydrocarbons. Usually some natural gas is produced along with the oil. The basic elements of the production system include the: reservoir, wellbore, tubulars, drill strings and associated equipment, wellhead, flowlines and processing equipment, and artificial lift equipment. The reservoir is the source of fluids for the production system. It is often the porous, permeable media in which the reservoir fluids are stored and through which the fluids will flow to the wellbore.

Abbreviations used herein are as follows: cp=centipoise; g=grams; bbl=42 gallon barrel; ppg=pounds per gallon; ppb=pounds per barrel; psi=pounds per square inch; rpm=revolutions per minute; STI=shear thinning index which is the ratio of the 0.5 rpm Brookfield viscosity and the 100 rpm Brookfield viscosity, a measure of the degree of shear thinning of a fluid; vol.=volume.

Historically, the drilling of oil and gas wells was a relatively straightforward process. The key endeavor of any project was the drilling function, which often represented 70-80% of the cost of drilling a well. Once a geologically viable, oil-producing target was identified, a vertical well was drilled to the target depth. Once the target depth was achieved, production casing was run and various minor stimulation techniques were utilized to treat the well before initiating hydrocarbon production. Stimulation techniques as simple as pumping acid downhole to clean-up the reservoir immediately around the production casing were common with the drilling of vertical wells and often represented less than 10% of the total cost of drilling a well.

With respect to vertical drilling, many different drilling fluids were used to enable drilling. However, these fluids were primarily water-based fluid systems. In the process of drilling a vertical well, multiple formations would be encountered. In the Permian for instance, a new formation can appear every 500-1,000 ft of depth, for example. Drilling problems could arise at any depth. For instance, lost circulation of drilling fluid could manifest in a layer of formation that sits geologically above the target oil producing zone. This issue would be treated with lost circulation materials, such as ground walnut hulls. Once the issue was treated, drilling would resume until the target zone was reached. Ahead of reaching the target zone, issues encountered in drilling often did not create future issues with oil production because they occurred outside of the target producing zone. Thus, the combination of chemicals, additives and lost-circulation materials applied to treat a lost circulation issue generally did not threaten future oil production. If a well was drilled to a target depth of 5,000 ft, perhaps 90% of the total footage drilled occurred outside of the producing zone. Thus 90% of the chemicals, additives, and products used to enable the drilling were introduced to subterranean formations other than the target oil producing zone. In summary, the historical process of drilling a well may be outlined as follows: (1) drill a vertical well successfully to target formation and run production casing; (2) stimulate the well by applying acidizing or other cleanup operations; and (3) open the well and produce oil via natural formation pressure.

Wells are often created by drilling a hole, e.g., 5 to 50 inches in diameter, into the earth with a drilling rig that rotates a drill string with a bit attached. After each interval is drilled, sections of steel pipe (casing), slightly smaller in diameter than the borehole, are normally placed in the hole. Cement may be placed between the outside of the casing and the borehole. The casing provides structural integrity to the newly drilled wellbore, in addition to isolating high pressure zones from each other and from the surface. Drilling fluid, a.k.a. mud, is pumped down the inside of the drill pipe and exits at the drill bit. Drilling mud is a complex mixture of fluids, solids, and chemicals that must be carefully tailored to provide the correct physical and chemical characteristics required to safely drill the well. Particular functions of the drilling mud include cooling the bit, preventing destabilization of the rock in the wellbore walls, overcoming the pressure of fluids inside the rock so that these fluids do not enter the wellbore, and/or lifting rock cuttings to the surface. To remove drilled cuttings from the wellbore, the fluid flows upward in the annulus faster than the rate at which the cuttings would otherwise fall. The flow rate or annular velocity is limited by the output of the pump as well as pressure and formation considerations. However, the rate at which cuttings fall in a fluid can be reduced by increasing the viscosity and thixotropy of the fluid. The generated rock cuttings are then swept up by the drilling fluid as it circulates back to surface outside the drill pipe. The fluid then goes through shakers that strain the cuttings from the fluid, which may then be recirculated. The pipe or drill string to which the bit is attached is gradually lengthened as the well gets deeper by screwing in additional, e.g., 30-foot (9 m), sections or joints of pipe under the kelly or topdrive at the surface. Once the well has been drilled, it is completed to provide an interface with the reservoir rock and a tubular conduit for the well fluids.

A wellhead is a general term used to describe the component at the surface of an oil or gas well that provides the structural and pressure-containing interface for the drilling and production equipment. The tubing serves as the primary conduit for fluid flow from the reservoir to the surface, although fluids also may be transported through the tubing-casing annulus. As the fluid flows from the reservoir into and through the production system, it experiences a continuous pressure drop. The pressure begins at the average reservoir pressure and ends either at the pressure of the transfer line or near atmospheric pressure in the stock tank. In either case, a large pressure drop is experienced as the reservoir fluids are produced to the surface. The pressure reduction depends on the production rate and, at the same time, the production rate depends on the pressure change.

After drilling and casing the well, it must be completed. Completion is the process in which the well is enabled to produce oil or gas. In a cased-hole completion, small holes called perforations may be made in the portion of the casing which passes through the production zone, to provide a path for the oil to flow from the surrounding rock into the production tubing. After a flow path is made, acids and fracturing fluids may be pumped into the well to fracture, clean, or otherwise prepare and stimulate the reservoir rock to produce hydrocarbons into the wellbore. Finally, the area above the reservoir section of the well is packed off inside the casing, and connected to the surface via tubing. In many wells, the natural pressure of the subsurface reservoir may be high enough for the oil or gas to flow to the surface. However, this is not always the case, especially in depleted fields where the pressures have been lowered by other producing wells, or in low permeability oil reservoirs. In such cases, artificial lift methods may also be needed. Common solutions include downhole pumps, gas lift, or surface pump jacks. Many new systems have been introduced for well completion. These new systems allow casings to run into the lateral zone with proper packer/frac port placement for optimal hydrocarbon recovery.

With the advent and adoption of horizontal drilling for the purpose of extracting hydrocarbons from shale formations, a variety of evolutions have been observed. A successful project is now the culmination for four main categories of functions: drilling, hydraulic fracturing, drillout, and production.

Drilling now often accounts for 25-30% of total project cost, versus 80-90% for a vertical well. However, total footage drilled has increased considerably from approximately 5,000-10,000 ft to 10,000-25,000 ft or more. With a horizontal well, 50% or more of the total footage drilled may be exposed to the target producing zones. Due to the technical challenges of successfully drilling a horizontal lateral, new chemicals and additives are being utilized in the drilling mud. These chemicals and additives now have much greater exposure to the reservoir because of the placement of the horizontal lateral in the target zone and the length of the lateral being drilled (often two miles or more). The chemicals most commonly used involve water emulsified in oil.

When the well is completed, openings must be made in the casing and cement to allow oil and gas to flow into the well. A perforation tool with explosive charges may be used. Next, the frac job begins. Hydraulic fracturing is a well stimulation technology used to maximize the extraction of underground resources; including oil, natural gas, geothermal energy, and even water, by fracturing the formation to create enhanced pathways for the fluids to flow into gathering wells. Hydraulic fracturing is a stimulation technique that has become widely used by the oil and gas industry to enhance and sometimes enable shale oil and gas production. The maturation of this technology is the key driver behind the shale boom in the United States and around the world. In a hydraulic fracturing treatment, fluid is injected into the well at rates higher than the reservoir matrix will accept. Rapid injection produces a buildup in wellbore pressure until a pressure large enough to overcome rock stresses is reached. At this pressure, failure occurs allowing a crack or fracture to be formed. Continued fluid injection with selected proppant results in a high conductivity crack in the formation and thereby well stimulation. Hydraulic fracturing is a highly engineered process. Proper design of a frac job considers petrophysical rock properties, the fluid chemical and physical properties, and the characteristics of the proppant (e.g., sand and/or beads) used. Frac jobs are closely monitored for volume, pressure, flow rate, temperature, and other parameters. Careful construction of a well is an important precursor to fracking the well. Oftentimes, surface casing is inserted, and the casing is cemented in place to ensure good bonding between the casing and the walls of the drilled hole. Additional drilling, including the vertical and/or horizontal leg of the well, may be followed by cementing other layers of casing into place.

The level of permeability in a rock holding oil and gas dictates whether the reservoir may need to be hydraulically fractured. At lower permeabilities, such as shale, most wells will not flow economic quantities of fluids without extensive hydraulic fracturing. On a well with a long horizontal section in the hydrocarbon-bearing formation, the well may not be perforated and fracked all at once. Rather, it may be done in a series of stages, each being several hundred feet in length. The outermost stage may be segregated from the rest of the well with a plug. A perforating tool creates the openings in that section of pipe, and then the frac job is performed on that stage. When that stage of the frac job is finished, another plug may be set several hundred feet further back to create a second stage, and the perforation and fracking are repeated. This process continues until the entire length of the well in the formation has been completed. Oftentimes, the frac plugs must then be milled out. The mill out of frac plugs and frac sleeves often use coiled tubing (CT) and/or pulling units. These operations are often expensive and may require several days to complete. In the past, traditional milling procedures included numerous short trips, sometimes referred to as wiper trips. By optimizing fluids system technology, operators may be able to reduce costs and produce cleaner wellbores.

Stimulation (including fracking), now often accounts for approximately 50-70% of total project cost. Millions of pounds of proppants (often generically referred to as sand) are pumped in conjunction with hundreds of thousands of gallons of water treated with various additives and chemicals, including, for example, friction reducers, scale inhibitors, and surfactants. Thousands of gallons of chemicals introduced during the frac process are now co-mingled in the reservoir with chemicals introduced during the drilling process. Hydrocarbon producing shale reservoirs often contain water (formation water) equivalent or even exceeding in volume to the oil itself and the water must be produced in conjunction with the oil. It is important that downhole emulsifications be prevented along with any other chemical coagulant that may impede successful oil production. Oftentimes, an emulsifying additive may be introduced to the entire producing zone during drilling, large volumes of water may be used in the frac process, and surfactants may be introduced during the frac, downhole emulsifications may be present in various parts of the reservoir.

To successfully frac the entire length of the horizontal lateral, plugs are used to isolate various zones, allowing for maximum pressure to be incrementally applied. Once the frac is complete, those plugs often need to be drilled out using techniques, chemicals, and fluids similar to those used in the drilling process. The drillout is yet another avenue where fluids may be introduced to the reservoir which may cause downhole emulsifications or other issues that may reduce or prevent successful hydrocarbon production and clog the reservoir around the tubing.

By way of example, a well may be drilled to a vertical depth of 8000 feet with a horizontal lateral length of 5500 feet. Typical completions often consist of multiple stages using the plug and perforate method. Locations are often multi-well pads that have, e.g., 4 to 6 wells per pad spaced 15 feet apart. In a typical wellbore, after fracking a well, CT, pulling units, or other systems may be utilized to drill out the plugs and clean the wellbore. Drillout operations often encounter large amounts of sand and debris which needs to be cleared from the wellbore. New wells often include lateral lengths of 7500 feet or more with many additional stages to the completion with more plugs to drill out. Thus, hole cleaning is often a major concern in horizontal well drillouts and cleanouts.

Crude oil is seldom produced alone because it generally is commingled with water. The water may create problems and usually increases the cost of oil production. An emulsion consists of a dispersion (droplets) of one liquid in another immiscible liquid. The phase that is present in the form of droplets is the dispersed or internal phase, and the phase in which the droplets are suspended is called the continuous or external phase. For produced oilfield emulsions, one of the liquids is aqueous and the other is crude oil. The amount of water that emulsifies with crude oil varies widely. It can range from, e.g., less than 1% to greater than 80%. Emulsions can be difficult to treat, difficult to separate, and may cause several operational problems, such as, for example, pressure drops in flow lines. Crude oil emulsions form when oil and water come into contact with each other, when there is sufficient mixing, and/or when an emulsifying agent is present. During crude oil production, there are several sources of mixing, often referred to as the amount of shear. The amount of mixing depends on several factors and is often difficult to avoid. Emulsions can form when fluid filtrates or injected fluids and reservoir fluids mix, or when the pH of the producing fluid changes, such as after an acidizing treatment. Most emulsions break easily when the source of the mixing energy is removed. However, some natural and artificial stabilizing agents, such as surfactants and small particle solids, may keep fluids emulsified. Natural surfactants, created by bacteria or during the oil generation process, can be found in many waters and crude oils, while artificial surfactants are part of many drilling, completion, or stimulation fluids. Among the most common solids that stabilize emulsions are iron sulfide, paraffin, sand, silt, clay, asphalt, scale, and/or corrosion products.

Formation damage during the drilling process due to invasion by fluids is another known problem. Many zones contain formation clays which hydrate when in contact with water such as the filtrate from fluids. These hydrated clays tend to block the producing zones so that oil and gas cannot move to the borehole and be produced. To avoid this, Low Shear Rate Viscosity (LSRV) fluids may be used. LSRV may be created by the addition of specialized chemicals to water or brines to form a drilling mud. These chemicals have a unique ability to create extremely high viscosity at very low shear rates. Viscosity describes a substance's resistance to flow. High-viscosity mud is typically described as “thick,” while low-viscosity mud is characterized as “thin.” LSRV fluids have been widely used in drilling operations because of their carrying capacity and solids suspension ability. They have been accepted as a way to minimize cuttings bed formation in high angle and horizontal wells. Examples include the aphron-containing well drilling fluids described in U.S. Pat. Nos. 6,422,326 and 6,716,797, both to Brookey, and both of which are hereby incorporated by reference.

After the drillout process, additional production chemicals may be introduced to improve the flow of oil, maintain oil-water separation, and prevent scale and paraffin build-up, among other things. The chemicals introduced during the production process may cause or sustain a downhole emulsification or other formation damage due to interactions with chemicals that, for example, may have been introduced to the formation during the drilling, frac, and/or drillout phases of the project. Due to the volume of sand pumped into a reservoir with each frac stage and due to the necessary flow from the reservoir back to the wellbore, many horizontal wells accumulate significant sand buildup, leading to diminished hydrocarbon production. These wells often need to be cleaned out in order to maximize economic recovery. Similar to a drill out, it is still possible to expose chemicals to the wellbore during a clean-out that may damage the reservoir or have a negative reaction with chemicals introduced at a prior stage.

The production stage is the most important stage of a well's life, when the oil and gas are produced. By this time, the rigs used to drill and complete the well have moved off the wellbore, and the top is usually outfitted with a collection of valves called a Christmas tree. These valves regulate pressures, control flows, and allow access to the wellbore in case further work is needed. From the outlet valve of the Christmas tree, the flow can be connected to a distribution network of pipelines and tanks to supply the product to refineries, natural gas compressor stations, or oil export terminals. As long as the pressure in the reservoir remains high enough, the Christmas tree is all that is required to produce the well.

If the pressure depletes and it is considered economically viable, an artificial lift method may be used. Workovers are often necessary in older wells, which may need smaller diameter tubing, scale or paraffin removal, acid matrix jobs, or completing new zones of interest in a reservoir. Such remedial work can be performed using workover rigs, for example, to pull and replace tubing and/or provide other well intervention techniques. Enhanced recovery methods such as water flooding, steam flooding, or CO₂ flooding may be used to increase reservoir pressure and provide a sweep effect to push hydrocarbons out of the reservoir. Such methods may require the use of injection wells and may be used when facing problems with reservoir pressure depletion, high oil viscosity, or sometimes early in a field's life.

In summary, the current landscape for developing a horizontally drilled, hydrocarbon producing project involves a series of chemicals introduced at various stages. The chemicals utilized in drilling operations are often vastly different from the chemicals used in frac operations. The chemicals used in drillout operations are often vastly different from the chemicals used in frac operations. The chemicals used in production operations are often vastly different from the chemicals used in drillout operations. The lack of continuity among the various stages often results in vastly more chemicals being introduced to a reservoir than is actually necessary to successfully produce the reservoir. Even if all chemicals applied to a reservoir are non-damaging to the formation, each additional chemical introduced represents incremental invasion of a foreign substance that is oftentimes not environmentally friendly and often inhibits the ultimate production of the well.

In recent years, several countries around the world have recognized the need to reduce the amount of non-biodegradable materials used and the emission of carbon dioxide and other greenhouse gases. Many countries have established targets for the reduction of greenhouse gases, which implies both a reduction in the use of non-biodegradable materials and an increase in the use of biodegradable materials. Several countries in the world have agencies and regulations governing the use of chemical substances and the evaluation of their potential impacts on both human health and the environment, including the Environmental Protection Agency (EPA), National Health Surveillance Agency (ANVISA), and the Registration, Evaluation, Authorisation and Restriction of Chemicals (REACH). Accomplishing these targets will require developing new materials as well as replacing toxic and non-biodegradable materials and sources of energy with currently available alternatives that are non-toxic and biodegradable.

Biodegradability is fundamental to the assessment of environmental exposure and risk from chemical products. In general, what makes a product biodegradable is the ability for a product to be consumed by microorganisms. A product's ability to biodegrade depends on the amount of carbon available for microbial consumption. From a microbial perspective, there are two methods for biodegradation—aerobic, in which organisms use oxygen as part of the respiration for consumption of nutrients, and anaerobic, in which organisms use other elements, such as sulfur, in the process of respiration and consumption of nutrients. Although biodegradation in the real world typically involves a continuum of these two processes, at present, regulations require biodegradability claims to be based on aerobic biodegradation, which typically measures oxygen consumption, CO₂ production, and the state of inorganic carbon intermediates.

Biodegradation testing is commonly performed to meet environmental regulatory requirements and for product marketing claims. Biodegradability testing measures the complex biochemical process that occurs when microorganisms consume a given type of material. Although complicated, the test results measure relatively simple markers of the biodegradation process. Currently, unless a product is 100% naturally derived and not materially changed in the manufacturing process, testing must be performed to enable a supplier to make legitimate claims on a products biodegradability. There are many standardized biodegradation testing methods depending on the product composition and intended application including, for example, OECD 301, OECD 306, OECD 310, ASTM D5864, and ISO 14593, among others. For example, ultimate biodegradation testing by methods such as OECD 306 and 310 may be needed for lubricants in order to meet regulatory biodegradability requirements, whereas laundry detergents may be better tested under OECD 301 ready biodegradability testing or the equivalent ISO methods.

Biodegradation testing for lubricants using one of the above methods is becoming standard in several market sectors, including energy production, surface transportation, mass transit, marine environments, construction equipment, and mining, because lubricants can leak and present an environmental challenge both on land and in water. The EPA defines an environmentally acceptable lubricant as a lubricant that has met standards for biodegradability, toxicity, and bioaccumulation potential that minimize likely adverse consequences in an aquatic environment as compared to conventional lubricants.

The highest level of biodegradation that can be demonstrated and claimed is called “ready biodegradability.” Materials that meet this most stringent classification are expected to rapidly and completely biodegrade in an aquatic environment under aerobic conditions. Test methods such as OECD 301, OECD 306, and ASTM D5864 test for ready biodegradability of a material in fresh or marine water environments are generally accepted by regulatory and labeling agencies. For classification as “ready biodegradable,” standard methods generally require the material to biodegrade by 60% or 70% in the first 10 days of a standard 28-day liquid biodegradation test. Some tests may look for 60% ThCO2 production (temperature humidity CO₂); 60% ThOD consumption (theoretical oxygen demand); and 70% dissolved organic carbon (DOC) removal, among other things.

Biodegradation of oil and oil-based products may be required for a product to be accepted for use in many markets. Biodegradation requires microbes to consume contents of the material in the various stages of extraction, production, storage, and distribution for oils and oil-based products. Although many petro-chemical products are susceptible to microbes during production and storage, this doesn't mean they will easily biodegrade in the environment. Biodegradation tests like OECD 301B are used to demonstrate whether an oil will degrade in a natural aqueous environment and, if so, how it may affect the surrounding environment. Thus, biodegradation testing, when intended for product claims related to biodegradability, often incorporate several factors of the product's actual performance n a given or intended use environment. For example, products successfully tested to “ready biodegradability” standards using the OECD 301B biodegradation test method can make claims related to that specific level of biodegradability, but products tested to different biodegradation test standards such as the OECD 302B product test method cannot make these same claims. The same claims cannot be made due to the differences in how the methods are designed to measure biodegradation and their accommodation of different types of materials.

OECD 301B is an aerobic biodegradation test that introduces a material to an inoculum in a closed environment and measures biodegradation of the material by CO₂ evolution. OECD 301B uses respirometry to determine the biodegradability of the material by evaluating the production of CO₂ over a minimum of 28 days in a liquid environment. The OECD 301B test method can be used for highly soluble, poorly soluble, and even for materials with certain concentrations known to be insoluble. Common materials tested with OECD 301B include fuels, lubricants, oil, surfactants, and personal care products. Formulations and other solutions can also be tested with the OECD 301B method. To be classified as readily biodegradable, a product has to meet the ready biodegradability requirements specified by the method.

In addition to ready biodegradability, there are also tests to determine ultimate biodegradability and inherent biodegradability. OECD 301 biodegradation methods typically run for 28 days. OECD 302 biodegradation methods are intended for longer term testing, often with more complicated solutions. Many other harmonized methods and variants of the OECD methods exist. The differences between these methods are often due to their focused applications or are simply adapted by the respective regulatory agency. Determining the most appropriate biodegradability test method begins with understanding a product's solubility and material composition. Choosing the correct method for biodegradability is closely related to the product's intended use and disposal. Related biodegradation methods include ASTM D5864, OECD 301 series, OECD 302, OECD 306, OECD 310 (Headspace Test), EPA 835.3110, and ISO 14593. There are a variety of OECD 301 ready biodegradability methods (and corresponding Guidelines), including 301A: DOC Die-Away; 301B: CO2 Evolution (Modified Sturm Test); 301C: MITI (I) (Ministry of International Trade and Industry, Japan); 301D: Closed Bottle; 301E: Modified OECD Screening; 301F: Manometric Respirometry.

Different compounds and formulations can be quite complicated and, depending on several factors (related to the chemical composition and physical properties of the material), these differences can make the measurement of biological degradation difficult. Depending on the formulation, a measurement of the actual DOC by a method such as OECD 301A, may be more appropriate for the material and provide a better understanding of the biodegradation occurring. For materials that are not expected to be fully degradable (Ready Biodegradation requires a very high degree of access or consumption by the microorganisms), this may not be feasible; so a measurement of oxygen (02) consumption may be more appropriate, such as measured by the OECD 301D method.

ASTM D5864 is a biodegradation test method for determining aerobic aquatic biodegradation of lubricants or their components. ASTM D5864 determines the degree of aerobic aquatic biodegradation of fully formulated lubricants or their components, based on the exposure to an inoculum under laboratory conditions. Testing is designed to be applicable to all lubricants that are not volatile and are not inhibitory at the test concentration to organisms present in the inoculum. The plateau level of CO₂ evolution in ASTM D5864 will suggest the lubricant's degree of biodegradability. Test substances that achieve a high degree of biodegradation are assumed to be easily biodegradable in many aerobic aquatic environments. ASTM D5864 is intended to specifically address the difficulties associated with testing water insoluble materials and complex mixtures often found in lubricants.

ISO 14593 is a solution biodegradation test that performs an evaluation of ultimate aerobic biodegradability of organic compounds in an aqueous medium. The ISO 14593 method analyzes inorganic carbon in sealed vessels (CO₂ headspace test). It is an aerobic biodegradation test method that was adapted from OECD 301B. Standard testing is a minimum of 28 days. The ISO 14593 test method is applicable to soluble, poorly soluble, volatile, and other materials that do not inhibit test organisms at the concentration chosen for testing.

In addition to using biodegradable compounds, in the oilfield, it is often beneficial to know the drilling fluid's viscosity and other rheological properties. Rheology is the science of the resistance of fluid to flow and looks at, for example, characteristics such as gel strength, funnel viscosity, plastic viscosity, and yield point. Rheological models are important because they are used to simulate the characteristics of the mud under dynamic conditions, such as equivalent circulating density, pressure drops in the system, and hole cleaning efficiency. The gel strength is the shear stress of drilling mud that is measured at a low shear rate after the drilling mud has been static for a certain period of time. The gel strength is an important drilling fluid property because it demonstrates the ability of the drilling mud to suspend solids and weighting material when circulation is ceased.

The funnel viscosity is the time (in seconds) for mud to flow through a Marsh funnel. The Marsh funnel is dimensioned so that the outflow of time of one quart of freshwater (946 cc) at a temperature of 70° F.±5° F. (21° C.±3° C.) in 26±0.5 seconds. For all drilling mud, especially oil based mud, temperate has an effect on the viscosity of a base fluid. The base fluid will often thin as the temperature increases, thus, the funnel viscosity will decrease. This is the reason why the viscosity measured from the Marsh funnel at the surface may not represent the true drilling mud viscosity downhole. On the drilling rig, this measurement of the mud viscosity is still useful because it is a quick and simple test for observing trends of drilling mud. In order to use the funnel viscosity effectively, the values are often recorded frequently so that trends in the funnel viscosity can be identified.

Plastic viscosity (in Centipoise) is the slope of shear stress and shear rate. Typically, a viscometer is utilized to measure shear rates at 600, 300, 200, 100, 6, and 3 revolutions per minute (rpm). In the field, the plastic viscosity can be determined using relatively simple calculations. An increase in solid content in drilling mud such as barite, drill solids, lost circulation material, etc., may result in higher plastic viscosity. In order to lower the plastic viscosity, solid content may be removed using filters and/or diluting drilling mud with a base fluid. Downhole temperatures often increase at increased depths, therefore the plastic viscosity of the drilling mud will decrease as the base fluid thins. Normally, the higher the mud weight, the higher the plastic viscosity will be. Moreover, if oil based mud is used, water in oil based drilling fluid will often act like a solid and it may increase the plastic viscosity dramatically. While thicker mud may cause a reduction in rate of penetration, an increase in solid content may increase the risk of differential sticking, especially in water based mud, due to an increased plastic viscosity.

Field experience indicates that LSRV is helpful in controlling the invasion of drilling fluids and filtrate by creating a high resistance to movement into the formation openings. Since the fluid moves at a slow rate, viscosity maintains rheology characteristics and the drilling fluid remains in the borehole with reduced penetration. This has been beneficial in protecting the zones from damage and reducing differential sticking in these fluids. Horizontal drilling, in particular, has increased the need to drill across zones that are not only low pressure, but highly fractured and/or permeable. The exposure of numerous fractures or openings having low formation pressures has increased the problem of lost circulation and formation invasion. This has led to the use of underbalanced drilling techniques to control the losses and invasion of these zones. Some of these techniques include the use of air, mist, and foam drilling fluids. Foaming occurs due to high interfacial surface tension phenomena or mechanical air entrapment. While a small amount of foaming occurs in most drilling muds and normally does not adversely affect the mud, there is a risk of serious mechanical damage to the pumps. For example, a pump may become locked if a large bubble of air passes into it or is formed within it by cavitation or any other phenomenon such as simple coalescence.

Before a well can be fractured, frac plugs are installed in the wellbore so that perforating operations can be carried out. Plug-and-perf is an inherently slow method for completing wells, by virtue of tripping in and out of the well with tools for every stage, then pumping the stimulation treatment. In vertical wells and later in single stage count horizontal wells, this operational time was not significant. Debris from mill cuttings was also less of an issue, because the plug debris just fell to the bottom of the well and did not inhibit current or future operations. However, as extended-reach laterals have become more commonplace and stage counts reach into the hundreds, a typical run-in rate of 200 to 300 ft/min can make for an onerous and expensive completion operation. When multi-stage hydraulic fracturing shifted from vertical wells to horizontal wells, and as horizontal wells became longer with tighter stage spacing to access more reservoir, stimulation operations became more time-consuming and complex.

Fracturing fluids generally include a viscosifying or gelling agent (such as a polysaccharide material or a viscoelastic surfactant) to increase the viscosity of the fluid and to enhance formation of a proppant bed into the fracture. It can be carried out by generating a foam on the surface and then injecting the foam under pressure into the formation. The foam can be generated on the surface by combining, for example, nitrogen gas or carbon dioxide with an aqueous fluid. Foam fracturing can also be carried out by generating a foam in the formation. Once the desired fracturing is achieved, pressure is released at the well head causing the foam to expand and exit the well. One method of fracturing with fluids containing aphrons is described in U.S. Pub. Pat. No. 2013/0126163, to Gupta, et al., which is hereby incorporated by reference.

While aphrons in LSRV fluids have been used in drilling, they have not been widely used in completion operations due to a variety of problems, including, for example, hole cleaning, control of formation fluids, corrosion, emulsions, and requirements for expensive, often hard to get equipment such as compressors and boosters. Additionally, the LSRV fluids that have been used have not been environmentally friendly. Thus, a method is needed to facilitate the use of aphrons in LSRV fluids for drillout and cleanout operations that avoids these problems.

While aphrons in LSRV fluids have been used in oil and gas production, to date, environmentally friendly LSRV fluids have not been available due to a variety of problems, including, for example, hole cleaning, control of formation fluids, corrosion, emulsions, and requirements for expensive, often hard to get equipment such as compressors and boosters. Thus, methods and compositions are needed to facilitate the use of aphrons in LSRV fluids for drillout and cleanout operations that are more environmentally friendly than those currently available. In addition, an invention is needed which reduces the number of harmful chemicals introduced to the formation by increasing the use of biodegradable compounds and providing continuity of chemistry from one phase to the next while decreasing negative reactions with ambient reservoir chemistry.

### SUMMARY OF THE INVENTION

Embodiments of the invention include methods of selecting and applying additives to each of the four processes applicable to successfully producing a horizontal well. Further, the invention embodies the processes and additives needed to manifest green, sustainable, environmentally friendly chemistry throughout the process. For purposes of this application, green, sustainable, environmentally friendly chemistry includes chemistry derived from agricultural sources (e.g., corn, potato starch), chemistry derived from naturally occurring biological sources (e.g., xanthan gum), chemistry supplied to the reservoir that is biologically good for the earth's ecosystem, chemistry supplied to the reservoir that is non-hazardous to animal and human consumption, and chemistry supplied that is largely derived from crops that absorb carbon. The goal of any hydrocarbon project is to produce as much hydrocarbon as possible from a reservoir. Thus, drilling, stimulation, drillout, and production chemicals must be identified and applied in a manner which a) reduces formation damage and b) reduces downhole emulsifications.

The goal of various embodiments of the invention is a continuity of chemistry whereby a primary fluid exhibiting certain characteristics may be used as a base fluid for drilling, as a frac additive for increasing lubricity and viscosity, as a drillout fluid when removing frac plugs, and as a production fluid to aid in cleaning the wellbore. By implementing a singular base fluid across multiple aspects of development, it may be possible to reduce formation damage and tailor the chemistry of the fluids and chemicals to increase the production potential of the target formation while supporting a sustainable economic and procurement cycle.

Formation damage is a condition most commonly caused by wellbore fluids used during drilling, completion, and workover operations. It impairs the permeability of reservoir rocks, thereby reducing the natural productivity of reservoirs. Formation damage can adversely affect both drilling operations and production, which directly impacts economic viability. Although the severity of formation damage may vary from one well to another, any reduction in recovery potential is unwanted. From the initial drilling operation and completion of a well to reservoir depletion by production, the effects of formation damage can negatively impact oil and gas recovery. Although formation damage may affect only the near-wellbore region of a well—reaching only a few centimeters from the rock face of the bore-hole wall—it can also extend deep into the formation. The damage may be caused by solids that migrate and block pores or by drilling fluids that alter the properties of reservoir fluids.

Some embodiments of the invention may include methods and compositions for the lightening of fluid in a more environmentally friendly manner for use in oil and gas operations and, in particular, drillout and cleanout operations in vertical and horizontal wellbores. In some embodiments, the environmentally friendly fluid lightening may be utilized after well completion processes, such as, for example, hydraulic fracturing, have been completed. In one embodiment, environmentally friendly fluid is provided that contains a base fluid, a viscosifying agent, aphrons, and a location specific non-emulsifying surfactant along with other optional specialty additives to allow the optimization and management of physical properties of rheology up to LSRV. In another embodiment, a production fluid from a well site may be tested and a plurality of different environmentally friendly fluids are added to a base fluid at the well site, including the addition of a viscosifying agent, aphron generator, and a location specific non-emulsifying surfactant, the type and volume of location specific non-emulsifying surfactant being determined based at least in part on the testing, or, if testing was not conducted, then based at least in part on estimated properties based on downhole characteristics of other wellbores in the same formation or other formations having similar characteristics. In another embodiment, the fluid combination may be reused at multiple wellbores and/or well sites.

In some embodiments, a new environmentally friendly fluid mixture is provided that combines the use of LSRV-generating polymers with surfactants to form colloidal gas aphrons at a concentration of between, e.g., 1 and 20 gallons per 100 barrels in a re-circulateable servicing fluid for use in, e.g., drillout and cleanout operations. The aphron generator forms microbubbles using encapsulated air available from, e.g., atmospheric pressure intentionally introduced to the circulating system. The low shear rate polymers help strengthen the microbubbles and provide a resistance to movement within the formation so that losses of fluid are reduced. In some embodiments, the fluid may include a location specific non-emulsifying surfactant to reduce downhole emulsifications.

In one embodiment, a process for using a re-circulateable environmentally friendly servicing fluid is provided having an enhanced LSRV containing aphrons and a location specific non-emulsifying surfactant. The process can comprise, consist essentially of, or consist of the stated steps with the stated materials. The compositions can comprise, consist essentially of, or consist of the stated materials.

In some embodiments, the process may utilize pre-job laboratory or field testing to determine that the fluid lightening system is compatible with reservoir fluids and produced components as well as the fluids that may be in the borehole prior to treatment. This can be accomplished by conducting simple graduated cylinder or bottle tests whereby samples of produced fluids (primarily crude oil) is mixed with the LSRV and fluid lightener (Xanthan-Aphron system) to determine compatibility. If stable emulsions form then varying quantities of additives and/or breakers designed to prevent (non-emulsifier), break (de-emulsifier or demulsifier) or solvent (EGMBE or other mutual solvent) the resultant stable emulsion may be added using standard rates of addition such as 0.5 gallon-1.0 gallon per 1000 gallons of emulsion volume or 0.05-0.1%. If emulsions are being produced prior to treatment or during the course of wellbore clean-out then a centrifuge test may also be run to determine the content of the emulsion (e.g., oil, water, solids).

In some embodiments, the process may include an oxidizer breaker such as, but not limited to, ammonium persulfate, can also be added to break the xanthan gum viscosifying component in the fluid lightener system. This viscosity may also be stabilizing any unwanted emulsification with crude oil once the well begins producing. The emulsion breaker is usually a surfactant and may be used alone or in combination with a mutual solvent. The gel breaker, including, but not limited to, an oxidizer, may be ammonium persulfate or a concentrated electrochemically produced anolyte, hypochlorous acid (HOCl), may also be incorporated within the fluid lightener mixture so as to be released upon the breakdown of xanthan or other polymer viscosity as well as any residual viscosity regardless of the source.

Testing and tests may include, but are not limited to, non-emulsion tests from mixing produced fluids with the LSRV Fluid Lightener treatment system and observing and validating compatibility. The LSRV fluid lightener system may be customized by adding certain environmentally friendly surface active chemistries, nanoparticle dispersions, pH adjustment chemistry, solvent chemistries, or a combination thereof to assure that the risk of creating any emulsion or flowback anomaly, permanent wettability change, or other impedance to well recovery and production will not occur.

Because aphron generation chemistry may contribute to some emulsification due to the presence of polymer (such as Xanthan Gum) and multiple surfactant structures containing microbubbles (aphron components), the process may include pre-job testing done to assure that an included emulsion prevention or oxidation breaker product that when added will adequately perform as required within an appropriate time frame. These may include certain surfactants and oxidizers that will, upon release after a pre-designated timeframe, breakdown the polymer stabilized aphron complex into its individual components and reduce the overall viscosity so that fluid recovery may be maximized.

The process may include additional specific emulsion prevention chemistries or technologies that will act to break down the emulsion stabilizing components of the system as well as any combination with produced or flood back reservoir fluids such as crude oil, fracturing load water, etc. and may also release additional emulsion prevention chemistries to further assure that any emulsion is broken and rendered as non-threatening, lower viscosity and/or residual product components.

In some embodiments, the testing step may be skipped and a non-emulsifier may be added. In some embodiments, the process may include performing a standard acidizing treatment (usually HCL or Acetic acid) to break the Xanthan polymer. This may involve using a pumped volume of a hydrochloric acid system (e.g., 3%-20% HCl) with appropriate corrosion inhibitor, which, when allowed to contact the Xanthan polymer stabilized Aphron system or LSRV, will degrade the Xanthan polymer to reduce viscosity and also can contain de-emulsifying surfactants which can aid in breaking the aphron based system simultaneously.

It should be considered that breaking an emulsion involves creation of mixing of the de-emulsification chemistry into and throughout the volume of the emulsion. This is more easily accomplished in bulk emulsions such as those contained inside tubular pipe and may be more difficult if the emulsion invades porous media such as reservoir rock. The presence of the emulsion preventative chemistry within the aphron fluid system will allow more efficient breakdown once it becomes active via a timed release, or based on temperature, pH, salinity or any combination thereof.

In some embodiments, the acid job may be skipped if the proper breaker/de-emulsifier chemistry can be incorporated into the LSRV mixture prior to being pumped into a wellbore. The process of running the aphron generation process can generate the desired lightening effects in a short amount of time to allow for effective wellbore cleaning and also allow the timed release and exposure of the breaker/de-emulsifying components thereby allowing them to effectively eliminate any created emulsion with hydrocarbon or remaining viscosity from residual polymer or other remaining viscosity from the low shear rate viscosity system (LSRV). Once an internal oxidizer breaker is active and simultaneously with appropriate de-emulsifier additives there can be a transition of flow characteristics from laminar to turbulent flow which further allows for more effective mixing and clean-up of the treatment components and separation of any residual lightener additives, crude oil, solids and/or water entrainment. This can be a very complex mixture, but if anticipated with the right broad spectrum treatment additive package may provide optimum cleanup and subsequently allow the well to be placed on well test or production.

The above summary of the invention is not intended to represent each embodiment or every aspect of the present invention. Particular embodiments may include one, some, or none of the listed advantages.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a flowchart of a method according to an exemplary embodiment;

FIG. 2 is a flowchart of a method according to an exemplary embodiment; and

FIGS. 3A-3C are examples of testing downhole fluids.

### DETAILED DESCRIPTION

The present invention is directed towards systems and methods for providing environmentally friendly chemicals used in downhole operations and, more particularly, to systems and methods for providing continuity of chemistry in drilling, servicing, cleanouts, and other operations related to oil and gas wells. Embodiments of the invention include methods of selecting and applying additives to each of the four processes applicable to successfully producing a horizontal well. Further, the invention embodies the processes and additives needed to manifest green, sustainable, environmentally friendly chemistry throughout the process. For purposes of this application, green, sustainable, environmentally friendly chemistry includes chemistry derived from agricultural sources (e.g., corn, potato starch), chemistry derived from naturally occurring biological sources (e.g., xanthan gum), chemistry supplied to the reservoir that is biologically good for the earth's ecosystem, chemistry supplied to the reservoir that is non-hazardous to animal and human consumption, and chemistry supplied that is largely derived from crops that absorb carbon.

The goal of any hydrocarbon project is to produce as much hydrocarbon as possible from a reservoir. Thus, drilling, stimulation, drillout, and production chemicals must be identified and applied in a manner which a) reduces formation damage and b) reduces downhole emulsifications. The goal of embodiments of the invention is a continuity of chemistry whereby a primary fluid exhibiting certain characteristics may be used as a base fluid for drilling, as a frac additive for increasing lubricity and viscosity, as a drillout fluid when removing frac plugs, and as a production fluid to aid in cleaning the wellbore. By implementing a singular base fluid across multiple aspects of development, it may be possible to reduce formation damage and tailor the chemistry of the fluids and chemicals to increase the production potential of the target formation while supporting a sustainable economic and procurement cycle.

Formation damage is a condition most commonly caused by wellbore fluids used during drilling, completion, and workover operations. It impairs the permeability of reservoir rocks, thereby reducing the natural productivity of reservoirs. Formation damage can adversely affect both drilling operations and production, which directly impacts economic viability. Although the severity of formation damage may vary from one well to another, any reduction in recovery potential is unwanted. From the initial drilling operation and completion of a well to reservoir depletion by production, the effects of formation damage can negatively impact oil and gas recovery. Although formation damage may affect only the near-wellbore region of a well—reaching only a few centimeters from the rock face of the bore-hole wall—it can also extend deep into the formation. The damage may be caused by solids that migrate and block pores or by drilling fluids that alter the properties of reservoir fluids. Significant damage may also occur from the use of emulsifying chemistry, highly prevalent in oil based mud systems presently in use. Oil based mud (OBM) is the most common drilling fluid utilized in drilling horizontal shale formations. Thus, when the drilling process is complete, the entire oil producing section of the wellbore, often 2 miles or more in length, has been coated with emulsifying chemistry. When frac operations commence, pressure, frac proppants and chemical slurries push this emulsifying chemistry beyond the wellbore and into the reservoir, allowing for emulsification of oil and reservoir water to occur. These emulsifications often manifest as glob-like coagulants. The purpose of any hydrocarbon project is to produce as much oil as possible and to create a strong flow from the reservoir to the wellbore. Thus, any emulsifications that occur ultimately flow back to the production casing, by design. As these emulsifications and coagulants near the wellbore, production is stifled due to the limited amount of entry points at the wellbore relative to the volume of oil the reservoir is intended to produce.

Base Drilling Fluid Additive. In various embodiments, a base drilling fluid is provided that may be based on a non-reservoir damaging fluid with an organic nature such that it minimizes adverse chemical reactions with the reservoir and minimizes the hindrance, alteration, pollution, or reaction with the reservoir while also reducing the amount of non-renewable carbon in the drilling fluid system. The fluid should preferably assist in achieving desired rheological properties dictated by conditions of the applicable and target formations. The fluid should have a high osmotic demand, such that the fluid remains stable under pressure and invasion of the reservoir is minimized. The fluid should be capable of blending with fresh water or saturated brine. The fluid should yield effective properties at various concentrations when blended with fresh water or brine water, including desired weight per gallon.

Base Drilling Fluid Additive Compatible with Non-Emulsifying Bio-Surfactant. Finally, the fluid should provide compatibility with the addition of a non-emulsifying bio-based surfactant to reduce emulsifications of oil and water in the reservoir while continuing to support the reduction of non-renewable carbon in the drilling fluid system.

A base drilling fluid should preferably offer the following characteristics (or derivatives thereof): (1) weight—the fluid should be capable of manipulation such that its weight per gallon allows for a prescriptive weight that prevents wellbore instability due to formation collapse; (2) lubricity—the fluid should be capable of providing lubricity such that the coefficient of friction is achieved which does not hinder the rate of penetration while drilling; (3) inhibition—the fluid should provide inhibitive characteristics such that the osmotic demand for the fluid overcomes the osmotic demand of the formation; (4) compatibility with bio-based, non-emulsifying surfactants that will reduce emulsifications of oil and water in the reservoir.

In various embodiments, utilization of Horizon Mud Company Inc.'s Clear Fluid product or other similar product, such as the product described in U.S. Reissued Patent RE47,362 to Rayborn et al., which is incorporated herein by reference, as a base for the drilling fluid may yield the performance characteristics mandated without damaging the reservoir. The Clear Fluid product may be mixed with fresh water or saturated brine in varying concentrations from, for example, 1% to 50% or more. The fluid may also be modified with xanthan polymer, Clear Seal-5, or other products to achieve desired rheology. For example, in one embodiment, one or more of the following chemicals may be added to the base fluid:

| Generic | Chemical Name | Units |
|---|---|---|
| Viscosifier | Xanthan Gum | 0.25-4 lb/bbl |
| Surfactant | Bio-Based Surfactant | 0.25-20 gal/100 bbl |
| Base Fluid Additive | Clear Fluid | 1-21 gal/bbl |
| Preservative | Horizon SPT | 1-20 gal/100 bbl |
| Lubricant | Bead Suspension | 0.25-210 gal/100 bbl |
| Shale Inhibitor | Gilsonite | 1-6%/bbl |
| Non-Emulsifying Surfactant | Bio-Based Surfactant | 0.25-20 gal/100 bbl |

In other embodiments, the concentrations and amounts may be varied according to the following chart:

| Generic | Chemical Name | Units |
|---|---|---|
| Viscosifier | Xanthan Gum | 0.3-4.0 lb/bbl |
| Surfactant | Bio-Based Surfactant | 1.5-2 gal/100 bbl |
| Fluid Lightener | Bio-Based Aphron | 4-10 gal/bbl |
| | Generator | |
| Preservative | Horizon SPT | 1-20 gal/100 bbl |
| Powdery Lubricant | Clear Seal 5 ™ | 5-7 oz/100 bbl |
| Biocode | Gluteraldehyde | 1-20 gal/100 bbl |
| Non-Emulsifying | Bio-Based Surfactant | 0.25-20 gal/100 bbl |
| Surfactant | | |

In some embodiments, one or more of the above chemicals may be replaced with suitable non-toxic, sustainable, and/or environmentally friendly chemicals. In other embodiments, the concentrations and amounts may be varied according to the following chart:

| Generic | Chemical Name | Units |
|---|---|---|
| Shale Stabilizer | Potassium Chloride | 2000-35000 ppm |
| Torque Reduction | Casing Butter ™ | 1-5%/bbl |
| Torque Reduction | H-DFL-A ™ | 1-5%/bbl |
| Torque Reduction | Horizon 1208 ™ | 1-5%/bbl |
| pH Control | CaOH− | 7-10.5 pH |
| Metal Binder | Iron Fix | 2-20 gal/100 bbl |
| Corrosion Inhibitor | Phosphate Ester | 1-10 gal/100 bbl |
| Remove Sulfites from System | Triazine | 1-10 gal/100 bbl |

Base Frac Fluid Additive. In various embodiments, a base frac fluid additive may be provided based on a non-reservoir damaging fluid with an organic nature such that it does not create an adverse chemical reaction with the reservoir nor does the presence of the fluid hinder, alter, pollute, or react with the reservoir in any material deleterious way. Additionally, the introduction of the frac fluid should not create any material adverse chemical reaction with any fluid or additive introduced during drilling operations. The base frac fluid additive must be capable of blending with a range of water often incorporated in modern frac operations including produced water, lease water, fresh water, and other waters containing wide ranges of iron, chlorides, bromides, chromium, and other elements found in untreated water. Additionally, the additive should be capable of improving lubricity and improving sand carrying capabilities of the frac fluid. The additive should complement any friction reducers added in order to achieve the desired rate (bbl/min) for fluid pumped during each frac stage. The fluid should further be capable of replacing or reducing the need for other lubricating or friction reducing or viscosifying agents which are not green in nature.

The utilization of the Clear Fluid product as a frac additive creates a simplified frac fluid capable of reducing friction, increasing sand carrying capacity, and eliminating reservoir damage due to the continuity of chemistry from drilling operations to frac operations. In various embodiments, the base fluid may be combined with one or more of the chemicals set forth above with respect to the base drilling fluid.

Base Drillout Fluid additive. Drillout fluids should be non-reservoir damaging and non-emulsifying since they circulate inside a perforated wellbore inside a completed reservoir. Oftentimes, the fluid weight of the drillout fluid needs to be manipulated as described in more detail below. In some embodiments, Horizon Mud Company, Inc.'s HFL-100 product, or other similar product may be added. By incorporating Clear Fluid with the HFL-100 product, a green, non-emulsifying fluid with enhanced polymer properties capable of a wide range of fluid weights and viscosified properties may be achieved capable of assisting with cleaning the wellbore of sand, plug parts, and debris while reducing damage to the reservoir. In various embodiments, the base fluid may be combined with one or more of the chemicals set forth above with respect to the base drilling fluid.

Production Fluid Additive. As horizontal wells produce oil, sand continually moves from the reservoir back towards the production pipe. From time to time, a cleanout is needed to remove sand and debris that inhibit maximum oil production. In various embodiments, utilization of Horizon Mud Company Inc.'s Clear Fluid product or other similar product, as a production fluid additive may yield desired performance characteristics while reducing damage to the reservoir. The Clear Fluid product may be mixed with fresh water or saturated brine in varying concentrations from, for example, 1% to 50% or more. The fluid may also be modified with xanthan polymer, Clear Seal-5, or other products to achieve desired rheology. In various embodiments, the base fluid may be combined with one or more of the chemicals set forth above with respect to the base drilling fluid.

In various embodiments, the utilization of chemical continuity is directed towards systems and methods for providing a fluid additive (either as a base fluid or as a fluid added to a base fluid) that can be used in various phases of downhole operations. In some embodiments, the fluid additive may be utilized during each of the drilling, fracking, completion, and production phases. For example, the fluid additive may be utilized as a base drilling fluid and then again (either as a newly added fluid or reuse of the drilling fluid) during reservoir stimulation processes, including, for example, hydraulic fracturing, and after those processes have been completed, where the servicing fluid will be introduced inside a cased hole where the removal of frac plugs, sand, and/or bi-products of prior drilling and completion servicing operations may be necessary to enhance the ultimate production of oil and gas. In some embodiments, the fluid additive may reduce the occurrence and/or severity of downhole emulsifications in the reservoir and/or reservoir damage from losses of the circulating fluid to the reservoir. In some embodiments, the fluid additive may maintain a fluid weight that does not overcome the maximum allowable downhole pressure gradient. In some embodiments, the fluid additive may be used as a drillout and cleanout fluid comprising an aqueous liquid having a water-soluble polymer hydrated therein and a surfactant. In some embodiments, the fluid additive may be used in conjunction with fresh water, saturated brine, cut brine, re-processed produced water, Potassium Chloride (KCl), Calcium Chloride (CaCl), and/or produced water.

In accordance with various embodiments, the method of using the fluid additive may begin at a drilling phase. In various embodiments, samples of fluids produced from nearby wells or known characteristics of wells from the same formation may be analyzed to determine chemical requirements for drilling fluid. Samples of fluids may be taken from nearby wellbores having the same or similar characteristics, for example from the same formation. As part of the testing, in some embodiments, the wellbore fluid is tested at or near the downhole temperature in order to obtain more accurate results.

During the initial build phase, one or more of the base fluid, preservatives, a pH control, polymers, surfactants, specialty chemicals, a fluid lightener, and lubricants are added in a mixing process. After an initial (or subsequent) drilling stage is complete, the fluid additive may be utilized as a base frack fluid or may be added to a base fluid. Oftentimes, a proppant is also added to the frack fluid. Following fracking, the fluid additive may be utilized in a drillout operation. In various embodiments, the fluid additive may be a base fluid added to a mixing pit. In some embodiments, the base fluid may be Clear Fluid or the base fluid may be water and the fluid additive may be Clear Fluid added to fresh water. In a preferred embodiment, the base fluid does not include a friction reducer and may be a low chloride solution. In other embodiments, the base fluid may be brine. Next, a viscosifier is added to the base fluid. In a preferred embodiment, the viscosifier is Xanthan gum, commonly referred to as XC. Depending on the chemical properties of the base fluid and/or the wellbore fluid, the viscosifier may be a dried XC or may be a liquid XC. For example, in embodiments needing less and/or slower hydration, a dried XC may be utilized. In some embodiments, the XC may be a dried material suspended in oil. Next, aphrons may be added to the mixture and the mixture may be agitated to stimulate the formation of aphron bubbles, for example, the mixture may be agitated for less than 5 minutes, between 5 and 30 minutes, or more than 30 minutes. Next, the aphron containing fluid may be transferred to a supply barrel and a non-emulsifying surfactant may be added to strengthen the wall coat of the aphron bubbles, either before or after being transferred to the supply barrel. In various embodiments, a lower grade XC may be added to strengthen the bubble carrier. Next, the solution is added to the production mud and the aphron-containing mud is circulated downhole. Other methods and chemicals may be utilized at various stages.

In other embodiments, aspects of the present invention are directed towards systems and methods for providing fluid lighteners that utilize green, sustainable, and environmentally friendly component parts and, more particularly, to systems and methods for utilizing green, sustainable, environmentally friendly fluid lighteners for downhole operations. For purposes of this application, the OECD 301B standard, or a similar standard recognized in the industry or approved by one or more regulatory agencies, shall be applied when considering the environmentally friendly nature of the fluid lightening methods and compositions. In preferred embodiments, the term sustainable shall be applied to fluid lightening methods and compositions that use products sourced from bio-derived molecules harvested from plant-based raw materials. As used herein, the term HFL-Green shall refer to a fluid lightening system, method, product, composition, ingredient, or component part that is both sustainable and environmentally friendly—meaning it has passed (or would pass if tested) the OECD 301B test, or a similar or equivalent test, and is sourced from bio-derived molecules harvested from plant-based raw materials or other environmentally friendly raw materials. The OECD 301 guideline, which includes an outline of the OECD 301B testing method, is incorporated herein by reference.

In some embodiments, the fluid lighteners may be utilized where reservoir stimulation processes, including, for example, hydraulic fracturing, have been completed and where a servicing fluid will be introduced inside a cased hole where the removal of frac plugs, sand, and/or bi-products of prior drilling and completion servicing operations may be necessary to enhance the ultimate production of oil and gas. In some embodiments, the servicing fluid may reduce the occurrence and/or severity of downhole emulsifications in the reservoir and/or reservoir damage from losses of the circulating servicing fluid to the reservoir. In some embodiments, including those in which artificial lift is required to enhance oil production, the servicing fluid may maintain a fluid weight that does not overcome the maximum allowable downhole pressure gradient. In some embodiments, a well drillout and cleanout fluid is provided comprising a base liquid, a first type of a surfactant, a second type of surfactant, a solvent, and other additives. In some embodiments, all of the components and additives are environmentally friendly and sustainable. In other embodiments, a majority of the chemicals added to the base liquid are environmentally friendly and sustainable. In other embodiments, a majority of the servicing fluid, by weight and/or by volume, is environmentally friendly and sustainable. In some embodiments, the drillout and cleanout fluid may comprise an aqueous liquid having a water-soluble polymer hydrated therein and a surfactant. In some embodiments, the base liquid may be fresh water, saturated brine, cut brine, re-processed produced water, Potassium Chloride (KCl), Calcium Chloride (CaCl), and/or produced water.

The term surfactant, as used herein, refers to compounds having an amphiphilic structure which gives them a specific affinity for oil/water-type and water/oil-type interfaces which helps the compounds to reduce the free energy of these interfaces and to stabilize the dispersed phase of a microemulsion. The term surfactant encompasses cationic surfactants, anionic surfactants, amphoteric surfactants, nonionic surfactants, zwitterionic surfactants, and mixtures thereof. In some embodiments, the surfactant is a nonionic surfactant, which generally do not contain any charges. Amphoteric surfactants generally have both positive and negative charges, however, the net charge of the surfactant can be positive, negative, or neutral, depending on the pH of the solution. Anionic surfactants generally possess a net negative charge. Cationic surfactants generally possess a net positive charge. The term surface energy, as used herein, refers to the extent of disruption of intermolecular bonds that occur when the surface is created (e.g., the energy excess associated with the surface as compared to the bulk). Generally, surface energy is also referred to as surface tension (e.g., for liquid-gas interfaces) or interfacial tension (e.g., for liquid-liquid interfaces). Surfactants generally orient themselves across the interface to minimize the extent of disruption of intermolecular bonds (i.e., lower the surface energy). Typically, a surfactant at an interface between polar and non-polar phases orient themselves at the interface such that the difference in polarity is minimized.

In some embodiments, the first and/or second surfactant may be a blend of anionic and non-ionic surfactants and co-surfactants in an aqueous solution that provide low-shear-rate viscosity (LSRV) and encapsulate air in the fluid creating micro-bubbles. In some embodiments, the first surfactant may be a viscosifier, such as, for example, Xanthan gum, commonly referred to as XC. In various embodiments, the XC used is environmentally friendly and sustainable. Depending on the chemical properties of the base fluid and/or the wellbore fluid, the viscosifier may be a dried XC or may be a liquid XC. For example, in embodiments needing less and/or slower hydration, a dried XC may be utilized. In some embodiments, the XC may be a dried material suspended in oil. In some embodiments, the second surfactant may be an aphron generator comprised of a bio-based surfactant mixture comprising Aliphatic Aryl Acid (e.g., 5-10%); Organic Acid (e.g., 1-5%); a first surfactant (e.g., 10-15%), and a second surfactant (e.g., 5-10%) may be added to generate aphrons with conventional mixing and surface equipment rigs. In some embodiments, the second surfactant may be an aphron generator comprising ethylene glycol monobutyl ether (EGMBE) (e.g., 15-20%); methanol (e.g., 10-30%); and isopropyl alcohol (e.g., 5-10%) may be added to generate aphrons with conventional mixing and surface equipment rigs. In other embodiments, the first surfactant and the second surfactant may be the same and may be added at different times and/or different concentrations. A description of Aliphatic Aryl Acid and derivatives thereof is provided in U.S. Pat. No. 5,238,832, which is hereby incorporated by reference. Once the base fluid has been built to a minimum LSRV of, for example, 50,000 cPs, the aphron generator may be added through the mud hopper. The air, shear, and pressure drop associated with mixing through the hopper may be used to create a 10-15% volume of aphrons in the base fluid. The concentration of aphron-generating surfactant required is generally less than the critical micelle concentration (CMC) of the surfactant or surfactant mixture. An indication of the volume of aphrons generated can be obtained by determining the density reduction which occurs upon generating the aphrons in the fluid. Foaming of the fluid, which is undesirable, can occur if the concentration of aphron-generating surfactant is excessive. Typically, the concentration of surfactant can be increased as the LSRV increases. Thus, the concentration of aphron-generating surfactant is the amount required to generate sufficient aphrons to give the density reduction desired but insufficient to create a long-lasting foam on the surface of the fluid.

In some embodiments, a de-emulsifying surfactant may be used in conjunction with the aphron generator on clean outs to help eliminate emulsion between the water and oil and between the aphron-containing fluid and the oil. In some embodiments, one or more de-emulsifying surfactants may be added to a sample of production fluid and tested at temperatures approximating downhole temperatures to determine which de-emulsifying surfactant(s) should be added to the base fluid. In some embodiments, the de-emulsifying surfactant may include a solvent, a co-solvent, or a mutual solvent, which, when combined with other additives, may enhances the shell structure of micro-bubbles to reduce permeability of the shell. In some embodiments, the solvent may be selected from the group comprising: short chain alcohols, methanol, ethanol, isopropyl alcohol, ethylene glycol, propylene glycol, dipropylene glycol monomethyl ether, triethylene glycol, ethylene glycol monobutyl ether (EGMBE), tetrahydrofuran, dioxane, dimethylformamide, and dimethylsulfoxide.

In some embodiments, the de-emulsifying surfactant may include diethanolamine, which may include compounds such as Cocamide, which is derived in part from coconut oil. Cocamide is the structural basis of many surfactants. Common are ethanolamines (cocamide MEA, cocamide DEA), betaine compounds (cocamidopropyl betaine), and hydroxysultaines (cocamidopropyl hydroxysultaine). Cocamide DEA, or cocamide diethanolamine, is a diethanolamide made by reacting the mixture of fatty acids from coconut oils with diethanolamine. It is a viscous liquid and is used as a foaming agent in products like shampoos and hand soaps, and in other products as an emulsifying agent. Cocamide is a mixture of amides manufactured from the fatty acids obtained from coconut oil.

In some embodiments, the demulsifying and/or the non-emulsifying surfactants or oxidizing breakers may be encapsulated or micro-encapsulated within a water soluble or water dispersible encasement such as gelatin, or other similar functioning material, so as to allow a delayed or longer lasting release of the non-emulsifying or de-emulsifying surfactants, while keeping them from disrupting the Aphron generating surfactants and xanthan polymer combination in the LSRV treatment system and generation process. Once the complete LSRV lightener system is created, it may also contain an encapsulated or microencapsulated non- or de-emulsification surfactant from the embodiments previously stated. In such embodiments, the mixture will function as the LSRV Xanthan polymer and generated aphron system which will function as previously described in the wellbore cleanout process, but will also contain the capability to prevent or break emulsions with encountered crude oil, water, and solids, as well as functioning to reduce the treatment fluid viscosity and stability so that the treatment and wellbore may be more easily recovered and/or cleaned up prior to being placed in production.

The alcohol, or combination of alcohols, may serve as a coupling agent between the solvent and the surfactant and aid in the stabilization of the aphron-containing fluid. In some embodiments, the alcohol is selected from primary, secondary, and tertiary alcohols having between 1 and 20 carbon atoms. Non-limiting examples of alcohols include methanol, ethanol, isopropanol, n-propanol, n-butanol, i-butanol, sec-butanol, iso-butanol, and t-butanol. In some embodiments, the alcohol is ethanol or isopropanol. In some embodiments, the alcohol is isopropanol. In some embodiments, the de-emulsifying surfactant may include an alcohol blend of methanol and iso-propyl alcohol which have low grade surfactant properties, but also act as solvents in many fluid additives. In some embodiments, it may include a linear alcohol ethoxylate surfactant. Alcohol ethoxylates (AE) and alcohol ethoxysulfates (AES) are surfactants found in products such as laundry detergents, surface cleaners, cosmetics, agricultural products, textiles, and paint. Alcohol ethoxylate based surfactants are non-ionic. Examples synthesized on an industrial scale include octyl phenol ethoxylate, polysorbate 80 and poloxamers. Ethoxylation is commonly used to increase water solubility. They often feature both lipophilic tails and relatively polar headgroups. AES generally are linear alcohols, which could be mixtures of entirely linear alkyl chains or of both linear and mono-branched alkyl chains. An example of these is sodium laureth sulfate a foaming agent in shampoos and liquid soaps, as well as industrial detergents.

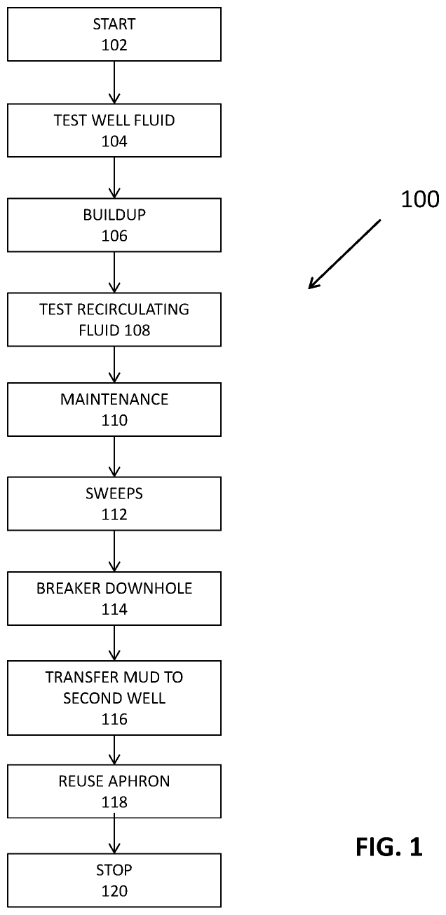

In accordance with the embodiment shown in FIG. 1, the method (100) of using an environmentally friendly and sustainable fluid lightener may begin at step 102 and proceed to a testing phase (104), an initial build phase (106), a maintenance phase (110), and a sweeps phase (112). During the testing phase (104), samples of fluids produced from a stimulated wellbore, or from nearby wellbores or wellbores from the same or similar formations, may be analyzed to determine, among other things, water type and surfactant requirements to reduce downhole emulsifications during the application of the servicing fluid. In embodiments where testing is not done, whether for economic reasons or because the servicing fluid is needed prior to production, for example in an initial drill out phase, characteristics may be estimated based on information about similar wells or samples of fluids may be taken from similar wellbores and/or nearby wellbores having the same or similar characteristics, for example from the same formation or from a different formation having similar characteristics.

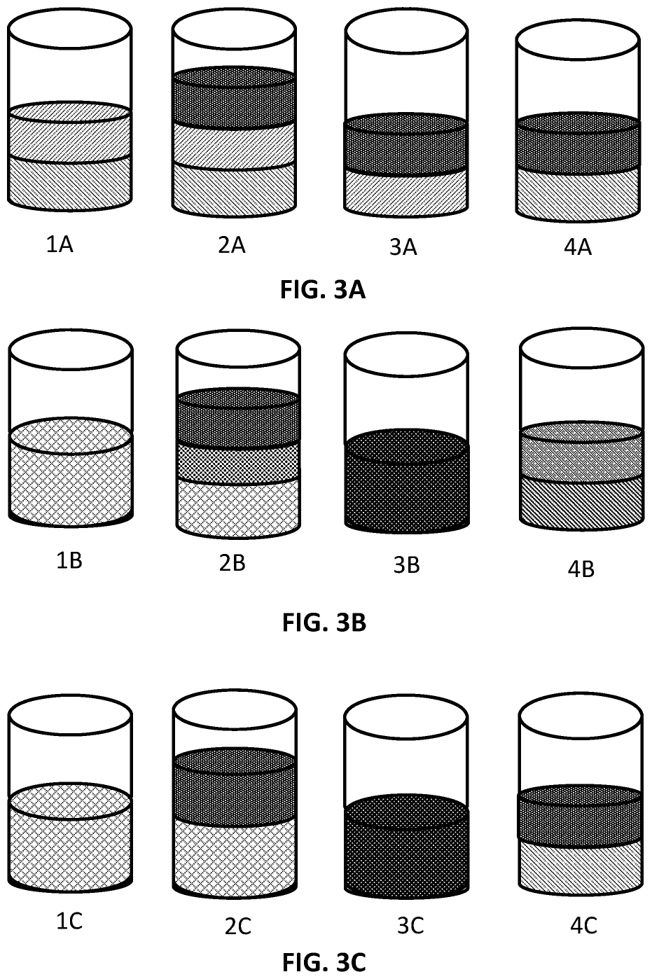

Referring now to FIGS. 3A-3D, samples of fluids at various points in an embodiment of a method for testing and analyzing fluid samples are shown. In various embodiments, the testing process begins by obtaining samples of produced oil from the well head (or a nearby well head or a well having similar characteristics) or oil expected to have similar characteristics to the produced oil, produced water from the well head (or a nearby well head or a well having similar characteristics) or water expected to have similar characteristics to the produced water, and preparing a fluid lightener with and/or without a non-emulsifying surfactant. In various embodiments, the testing process may include running and/or rerunning one or more of the tests, or portions thereof, using only non-sustainable, non-environmentally friendly chemicals; using only sustainable, environmentally friendly chemicals; and/or using and/or replacing one or more non-sustainable, non-environmentally friendly chemicals with one or more sustainable, environmentally friendly chemicals. In such embodiments, the results of such tests may be used to optimize the chemicals being used; confirm the sufficiency and/or effectiveness of the sustainable, environmentally friendly chemicals; and/or compare the use of non-sustainable, non-environmentally friendly chemicals to the use of sustainable, environmentally friendly chemicals.

In various embodiments, non-sustainable, non-environmentally friendly chemicals and/or sustainable, environmentally friendly chemicals may be replaced with sustainable, non-environmentally friendly chemicals and/or non-sustainable, environmentally friendly chemicals. In the embodiment shown in FIG. 3A, the samples may be used to prepare four mixtures using various combinations of the samples. For example, Mix 1 (1A) may be formed from a mixture of the produced water (or fresh/brine water, if desired or if produced water is unavailable) and the fluid lightener, such as, for example, an aphron-containing fluid lightener, with and/or without a non-emulsifying surfactant. In various embodiments, equal parts of the produced water (fresh/brine water) and fluid lightener may be mixed together, such as, for example, 50 mL of water and 50 mL of fluid lightener with non-emulsifying surfactant. Mix 2 (2A) may be the same as Mix 1 with the addition of produced oil (or oil expected to have similar characteristics). In the embodiment shown, equal parts of each component have been added to Mix 2 (e.g., 50 mL of water, 50 mL of fluid lightener with non-emulsifying surfactant, and 50 mL of oil). In some embodiments, Mix 2 may be formed by combing the produced oil (or oil expected to have similar characteristics) and the produced water (or water expected to have similar characteristics) with the fluid lightener without the non-emulsifying surfactant. Mix 3 (3A) may be formed by combining the fluid lightener with non-emulsifying surfactant with the sample of produced oil (or oil expected to have similar characteristics). In some embodiments, Mix 3 may be formed by combining the produced oil (or oil expected to have similar characteristics) and the fluid lightener without the non-emulsifying surfactant. In the embodiment shown, equal parts of each have been added to Mix 3 (e.g., 50 mL of oil and 50 mL of fluid lightener). Mix 4 (4A) is formed by combining the produced oil (or oil expected to have similar characteristics) with the produced water (or water expected to have similar characteristics). In the embodiment shown, equal parts of oil and water have been added (e.g., 50 mL of oil and 50 mL of water). In some tests, more or less of each component may be added, the ratios of each component may be varied, the volumes of each component may be varied, some components may be left out and/or other components may be added. For example, in some embodiments, a first non-emulsifying surfactant may be added to the fluid lightener used in one or more tests and/or one or more mixtures, a second non-emulsifying surfactant may be added to the fluid lightener used in one or more tests and/or one or more mixtures, or the fluid lightener used in one or more tests and/or one or more mixtures may not include a non-emulsifying surfactant. In some embodiments, no testing is performed and, instead, a breaker is used to break any downhole emulsions. In such embodiments, the breaker may be added after the fluid lightener or a time-released or delayed reaction breaker may be added to the fluid lightener or after the fluid lightener.

Next, the mixtures may be vigorously agitated. As part of the testing, in some embodiments, the mixtures may be tested at or near the downhole temperature in order to obtain results approximating downhole conditions. In some embodiments, the mixtures may be observed immediately after agitation and/or heating or may be placed in a roller oven and heated (e.g., 160° F.) and rolled to simulate downhole conditions, and observed at various time intervals (e.g., immediately and again at 1 hr, 4 hrs, 12 hrs, 24 hrs, etc.) for emulsion breaking in the mixtures. After agitations, all four mixtures may contain emulsions and/or be in suspension. As can be seen in FIG. 3B, after a first time interval, for example, of heating and rolling, Mix 1 (1B) and Mix 3 (3B) remain thoroughly mixed, while Mix 2 (2B) and Mix 4 (4B) have begun to separate. In particular, in Mix 2, the emulsion has separated into three layers, with the oil layer on top, the water+fluid lightener layer on bottom, and an emulsion in a middle layer. In Mix 4, the emulsion has begun to separate into an oil layer on top and a water layer on bottom, but some oil remains in the bottom layer and some water remains in the top layer.

As can be seen in FIG. 3C, after additional time has passed, Mix 1 (1C) and Mix 3 (3C) remain thoroughly mixed, while Mix 2 (2C) and Mix 4 (4C) have almost completely separated. In particular, in Mix 2, the emulsion has separated into an oil layer on top and a water+fluid lightener and non-emulsifying surfactant layer on bottom. In Mix 4, the emulsion has separated into an oil layer on top and a water layer on bottom. Although FIGS. 3A-3C show exemplary test results, many different results at different times and in different orders may be observed depending on the characteristics of the oil, water, fluid lightener, and/or non-emulsifying surfactant used. For example, in some embodiments, the emulsion of Mix 3 may separate out before, at the same time, or after the emulsions of Mix 2 and/or Mix 4 break. In some embodiments, Mix 4 (oil+water) may be utilized as a reference sample. Although not shown in the figures, in some embodiments, sand and other sediment and debris may settle out from the samples during the testing process. Based on the observations made during the testing phase, a combination of chemicals and/or surfactants can be optimized for the wellbore where the samples were taken (or a nearby wellbore or a wellbore estimated to have similar characteristics). For example, if the emulsions break quickly (for example, of Mixes 2 and/or 3 as compared to the reference sample (Mix 4)), a non-emulsifying surfactant may not be needed or less of the non-emulsifying surfactant may be needed. As another example, if the emulsions break slowly (for example, as compared to the reference sample), a non-emulsifying surfactant may be needed, more of the non-emulsifying surfactant may be needed, a different non-emulsifying surfactant may be needed, or a breaker may be needed. As another example, if a first non-emulsifying surfactant causes the emulsions to break faster than a second non-emulsifying surfactant, it may be desirable to use the first non-emulsifying surfactant or a breaker instead of the second non-emulsifying surfactant. The testing may include inspecting for the presence of emulsions and determining the chemical and rheological properties of the fluid. In various embodiments, the properties tested may include weight (lb/gal); funnel viscosity (sec/qt); plastic velocity (cP); yield point (lb/100 ft²); gel strength (10 sec/10 min) (lb/100 ft²); mud gradient (psi/ft); API filtrate (mL/30 min); LCM (lb/bbl) (in/out); cake thickness (API/HTHP); solids (% by vol uncorrected); oil content (% by vol); water content (% by vol); sand content (% by volume); pH (whole mud/filtrate); alkalinity (Pm); Chlorides (mg/L); total hardness (mg/L); Iron, PPM (mg/L); low gravity solids (% by vol); low gravity solids (lb/bbl); and/or other measurements.

Referring again to FIG. 1, during the initial build phase (106), one or more of the base fluid, preservatives, a pH control, polymers, surfactants, specialty chemicals, a fluid lightener, and/or lubricants may be added in a mixing process that exposes the ingredients to atmospheric pressure for the purpose of creating aphrons (i.e., an air and water emulsion). Various embodiments contemplate a servicing fluid comprised entirely of sustainable, environmentally friendly chemicals while other embodiments contemplate a servicing fluid comprised of a combination of sustainable, environmentally friendly chemicals and other non-toxic chemicals. In some embodiments, various specialty chemicals may need to be added to the servicing fluid depending on various factors, such as downhole well conditions. In such embodiments, the addition of specialty chemicals that may be non-sustainable and/or non-environmentally friendly would still be within the scope of the contemplated invention.

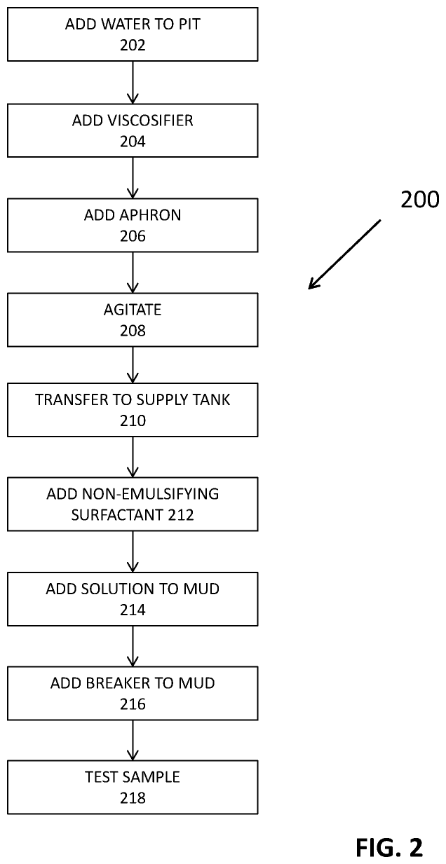

Referring now to FIG. 2, a fluid lightening method (200) is provided. At a beginning step (202), a base fluid is added to a mixing pit. In some embodiments, the base fluid may be fresh water. In a preferred embodiment, the base fluid does not include a friction reducer and may be a low chloride solution. In other embodiments, the base fluid may be brine. Next, a viscosifier is added to the base fluid (204). Next, an aphron generator is added to the mixture (206) and the mixture is agitated to stimulate the formation of microbubbles, for example, the mixture may be agitated for less than 5 minutes, between 5 and 30 minutes, or more than 30 minutes. Next, the aphron containing fluid is transferred to a supply tank (210) and a non-emulsifying surfactant is added (212), for example, to strengthen the wall coat of the aphron bubbles or to reduce the risk of downhole emulsions. In various embodiments, a lower grade XC may be added to strengthen the bubble carrier. In some embodiments, the non-emulsifying surfactant may be a delayed action breaker, whose ability to break the xanthan and/or aphron is delayed until a passage of time, a change in pH, a change in temperature, a change in pressure, or other factor, is added to the solution before the solution is added to the production mud. In some embodiments, the non-emulsifying surfactant may be added before the fluid is transferred to the supply tank. Next, the solution is added to the production mud (214) and the aphron-containing mud is circulated downhole. In some embodiments, the non-emulsifying surfactant may be added after the solution is added to the production mud. In some embodiments, a breaker, such as an oxidizer, ammonium persulfate, sodium hydrochloride, or bleach, is added to the production mud after the solution has been added (216). In some embodiments, a dye, or two or more different colored dyes, may be added to the solution or to the production mud, before, during, or after, one or more of the foregoing steps to provide a visual indication of the locations of the various chemicals in the recirculating fluid. In some embodiments, an acid job is added to the production mud after the solution has been added. In other embodiments, the process of adding the solution to the production mud includes adding the non-emulsifying surfactant and/or breaker and/or acid job, whenever the produced oil or an oil anticipated to have characteristics similar to the produced oil is not tested for a risk of emulsion.

In some embodiments, the non-emulsifying surfactant may be comprised of one or more of a demulsifying surfactant and/or an oxidizing breaker. In embodiments where the non-emulsifying surfactant is a delayed action breaker, the breaker may be encapsulated or micro-encapsulated within a water soluble or water dispersible encasement such as, for example, gelatin, or other similar functioning material, so as to allow a delayed or longer lasting release of the non-emulsifying or de-emulsifying surfactants, while keeping them from disrupting the aphron generating surfactants and xanthan polymer combination in the LSRV treatment system and generation process. In some embodiments, the mixture will function as the LSRV Xanthan polymer and generated aphron system which will function as previously described in the wellbore cleanout process, but will also contain the capability to prevent or break emulsions with encountered crude oil, water, and solids, as well as functioning to reduce the treatment fluid viscosity and stability so that the treatment and wellbore may be more easily recovered and/or cleaned up prior to being placed in production. The non-emulsifying surfactant may be encapsulated or microencapsulated and be time activated or solvent activated, wherein non-emulsifying, demulsifying, and/or oxidizing breakers are placed into one or more encapsulation materials, such as, for example, water soluble gelatinous pill capsules, a temporary coating of vegetable oil or other hydrocarbon liquid, which can be removed over time and/or by dissolution in water, or entrained within the emulsifying components used to make the aphrons or xanthan polymer LSRV system.

Referring back to FIG. 1, once the mud is circulating downhole, the maintenance phase (110) begins. During the maintenance phase, the fluid characteristics and properties achieved as a result of the chemicals added to the base fluid during the initial build phase (106) are monitored (108) and adjusted as needed due to, for example, variability of downhole conditions. Referring again to FIG. 2, when the aphron-containing mud returns to the surface, it may be filtered, such as with a shaker, and a sample of the filtered fluid may be taken at various intervals and tested (218). Depending on the test results, additional fluid from the supply barrel may be added to the mud and/or the rate of fluid addition may be increased or decreased, or additional chemicals may be added.

Referring back to FIG. 1, during the sweeps phase (112), the amounts of chemicals previously added (e.g., during the initial build phase) may be increased or decreased and/or other chemicals may be added to perform a sweep by changing the fluid profile. If, for example, production decreases, a sweep may be needed. Flow regimes are characterized by the relative amount of swirling or chaotic motion as the fluid moves along the pipe. Downhole fluid may have, in general, different flow regimes, such as laminar flow and turbulent flow. In between each zone, there is a transition zone where the flow regimes are changing. Laminar flow, which generally exists at the low shear rates encountered in the annulus, is the uniform movement of fluid elements parallel to the walls of the flow channel. A laminar regime flows smoothly with instabilities being dampened by the viscosity. Laminar flow usually occurs at a low flow velocity and it is best understood by considering mud as being layers of fluid flow. The velocity of the mud farthest away from any surface is moving the fastest and the velocity of a layer adjacent a surface moves slower. For the laminar flow, the flow has a predictable pattern, and the shear rate is a function of the shear stress of the fluid. Turbulent flow is an erratic, nonlinear flow of a fluid, caused by high velocity and low viscosity. Fluid moving in a turbulent flow region is subject to random local fluctuations in both the direction of flow and fluid velocity. During operations, it is often desirable to maintain laminar flow. The viscosity describes the measure of a fluid's resistance to flow. The flow of liquid through a pipe is resisted by viscous shear stresses within the liquid and the turbulence that occurs along the internal walls of the pipe which is created by the roughness of the pipe material. This resistance is usually known as pipe friction and is measured in feet head of the fluid, thus the term “head loss” is also used to express the resistance to flow. Simply stated, the less viscous the fluid, the greater its ease of movement through the pipe.

In the sweeps phase (112), an operator displaces the lateral with a breaker by, for example, increasing or decreasing the viscosity of at least a portion of the circulating fluid to cause a transition from laminar flow to turbulent flow. In some embodiments, fresh water (or other fluid having a low viscosity relative to the fluid in circulation) may be added to the circulating fluid to lower the viscosity and create turbulent flow to sweep or scour the downhole surfaces. In some embodiments, a breaker, such as Ammonium Persulfate, may be added to the circulating fluid to “eat” the XC to change the viscosity and create the turbulent sweep. In other embodiments, turbulent flow may be created by adding additional viscosifier to the circulating fluid. In some embodiments, the amount of modified fluid needed may be, for example, less than 10 bbl, between 10-15 bbl, or more than 15 bbl, and may vary depending on various fluid and downhole characteristics in order to cause a transition from laminar flow to turbulent flow. In some embodiments, a dye may be added to the modified fluid to provide a visual indicator when the modified fluid has returned to the surface.

Returning now to FIG. 2, in various embodiments, a base fluid is first modified with a viscosifier (204) to provide sufficient polymer loading. The viscosifier is added prior to the aphron-generating fluid lightener (206) to help maintain the integrity of the bubbles created by the fluid lightening additive in order to maintain the air and water emulsion while the servicing fluid is circulated to assist in cleaning the hole. The aphron generator creates microbubbles to lighten the fluid and the microbubbles are protected and enabled by first viscosifying the base fluid. In various embodiments, the viscosifier may provide sufficient protection of the aphron microbubbles to allow continued recirculation downhole. The aphrons are non-coalescing and capable of being recirculated so that density reduction may be accomplished without expensive air or gas injection. In other embodiments, a surfactant may be added (212) after the aphron generator is added to the viscosified fluid in order to enhance the microbubbles and help lower friction pressure by reducing surface tension. In some embodiments, the surfactant may be a non-emulsifying surfactant to reduce the occurrence or severity of the downhole emulsion of oil and water while the servicing fluid is being circulated. The servicing fluid is then able to successfully circulate through the wellbore and clean the wellbore without overcoming the downhole pressure gradient and while simultaneously reducing downhole emulsification of oil and water. In one embodiment, the fluid lightener may include one or more of the following chemicals added to the base fluid:

| Generic | Chemical Name | Units |
|---|---|---|
| Viscosifier | Xanthan Gum | 0.25-2.5 lb/bbl |
| Surfactant | Anionic Surfactant | 0.25-20 gal/100 bbl |
| Aphron Generator | Bio-Based Surfactant | 1-20 gal/100 bbl |
| | Mixture | |
| Preservative | Methyl Alcohol | 1-5 gal/100 bbl |
| Biocide | Gluteraldehyde | 1-15 gal/100 bbl |
| Colored Dye Marker | Colored Dye | 1-128 oz/100 bbl |
| Non-Emulsifying | Diethanolamine | .25-20 gal/100 bbl |
| Surfactant | | |

Glutaraldehyde, Methyl Alcohol, and Diethanolamine are hydrophilic compounds and considered to be readily biodegradable in both water and soil. In other embodiments, the concentrations and amounts may be varied according to the following chart:

| Generic | Chemical Name | Units |
|---|---|---|
| Viscosifier | Xanthan Gum | 0.3-1.5 lb/bbl |
| Surfactant | Anionic Surfactant | 1.5-2 gal/100 bbl |
| Aphron Generator | Bio-Based Surfactant | 4-10 gal/100 bbl |
| | Mixture | |
| Preservative | Methyl Alcohol | 1-2.5 gal/100 bbl |
| Colored Dye Marker | Colored Dye | 5-7 oz/100 bbl |
| Non-Emulsifying | Diethanolamine | 2.0-10.0 gal/100 bbl |
| Surfactant | | |
| Biocide | Gluteraldehyde | 1-5 gal/100 bbl |

In some embodiments, additional chemicals may be added to the base fluid depending on the needs of the well. For example, a water-based mud anti-foamer specifically formulated for use in aphron-containing water-based fluids may be necessary to treat surface foams without removing the aphrons from the system. These chemicals may include the following:

| Generic | Chemical Name | Units |
|---|---|---|
| Shale Stabilizer | Potassium Chloride | 2000-35000 ppm |
| Torque Reduction | CoPolymer Beads | 0.2-5 lb/bbl |
| Oxidizing Agent (breaker) | Ammonium Persulfate | 0.1-10 lb/1000 gal |
| Defoamer | Defoamer | 0.1-0.5% by volume |
| pH Control | CaOH- | 7-10.5 pH |
| Metal Binder | Iron Fix | 2-10 gal/100 bbl |
| Corrosion Inhibitor | Phosphate Ester | 1-10 gal/100 bbl |
| Remove Sulfites from | Triazine | 1-10 gal/100 bbl |
| System | | |

In some embodiments, one or more of the above chemicals may be replaced with suitable non-toxic, sustainable, and/or environmentally friendly chemicals. In other embodiments, the concentrations and amounts may be varied according to the following chart:

| Generic | Chemical Name | Units |
|---|---|---|
| Shale Stabilizer | Potassium Chloride | 2000-35000 ppm |
| Torque Reduction | CoPolymer Beads | 0.25-2 lb/bbl |
| Oxidizing Agent | Ammonium Persulfate | 2-3 lb/1000 gal |
| Defoamer | Defoamer | 0.1-0.2% by volume |
| pH Control | CaOH− | 8-10 pH |
| Metal Binder | Iron Fix | 6-7 gal/100 bbl |
| Corrosion Inhibitor | Phosphate Ester | 3-6 gal/100 bbl |
| Remove Sulfites from | Triazine | 1-3 gal/100 bbl |
| System | | |

In some embodiments, alternative chemicals may be added to the base fluid depending on the needs of the well and the availability and cost of the chemicals. In some embodiments, one or more of the below chemicals may be replaced with suitable non-toxic, sustainable, and/or environmentally friendly chemicals. These chemicals may include the following:

| Generic | Chemical Name | Units |
|---|---|---|
| Shale Stabilizer | Non-ionic Polymer | 0.1-10 gal/100 bbl |
| Torque Reduction | Lubricant w/ or w/o | 0.25-5% by vol. |
| | Beads | |
| Oxidizing Agent | Sodium Hypochlorite | as needed |
| | or Peroxide | |
| pH Control | NaOH | 7-10.5 pH |
| pH Control & Reduce | Na₂CO₃ | 7-10.5 pH |
| Hardness | | |
| pH Control & Potassium | KOH | 7-10.5 pH |
| Source | | |
| Corrosion Inhibitor | Filming Amine | 1-10 gal/100 bbl |

In some embodiments, one or more of the below chemicals may be replaced with suitable non-toxic, sustainable, and/or environmentally friendly chemicals. In other embodiments, the concentrations and amounts may be varied according to the following chart:

| Generic | Chemical Name | Units |
|---|---|---|
| Shale Stabilizer | Non-ionic Polymer | 0.25-5 gal/100 bbl |
| Torque Reduction | Lubricant w/ or w/o | 0.25-2% by vol. |
| | Beads | |
| Oxidizing Agent | Sodium Hypochlorite | as needed |
| | or Peroxide | |
| pH Control | NaOH | 8-10 pH |
| pH Control & Reduce | Na₂CO₃ | 8-10 pH |
| Hardness | | |
| pH Control & Potassium | KOH | 8-10 pH |
| Source | | |
| Corrosion Inhibitor | Filming Amine | 2-4 gal/100 bbl |

In some embodiments, alternative chemicals may be added to the base fluid depending on the needs of the well and the availability and cost of the chemicals. In some embodiments, one or more of the below chemicals may be replaced with suitable non-toxic, sustainable, and/or environmentally friendly chemicals. These chemicals may include the following:

| Generic | Chemical Name | Units |
|---|---|---|
| Viscosifier and Friction | PHPA | 0.1-10 gal/100 bbl |
| Reducer | | |
| Stabilizer, Friction | Polymerized | 0.25-10% by vol. |
| Reducer, Enhancer | Carbohydrate | |
| Shale Stabilizer | KCl Substitute | 0.25-3 gal/1000 gal |
| | (Choline Chloride) | |
| Shale Stabilizer | Potassium Acetate | 2000-5000 ppm |
| Shale Stabilizer | Potassium Carbonate | 2000-5000 ppm |
| Hole Stabilizer and | Hole Stabilizer/ | 0.2-5 lb/bbl |
| Viscosifier | Viscosifier | |

In other embodiments, the concentrations and amounts may be varied according to the following chart:

| Generic | Chemical Name | Units |
|---|---|---|
| Viscosifier and Friction | PHPA | 0.25-10 gal/100 bbl |
| Reducer | | |
| Stabilizer, Friction | Polymerized | 0.25-3% by vol. |
| Reducer, Enhancer | Carbohydrate | |
| Shale Stabilizer | KCl Substitute | 0.5-1 gal/1000 gal |
| | (Choline Chloride) | |
| Shale Stabilizer | Potassium Acetate | 2000-3000 ppm |
| Shale Stabilizer | Potassium Carbonate | 2000-3000 ppm |
| Hole Stabilizer and | Hole Stabilizer/ | 0.25-2 lb/bbl |
| Viscosifier | Viscosifier | |

The base aqueous fluid in which the low shear rate modifying polymer is hydrated may be any aqueous liquid which is compatible with the polymer. Thus, the base liquid may be fresh water, produced water, and/or a brine containing soluble salts such as sodium chloride, potassium chloride, calcium chloride, sodium bromide, potassium bromide, calcium bromide, zinc bromide, sodium formate, potassium formate, cesium formate, and the like. The brine may contain one or more soluble salts at any desired concentration up to saturation. The fluids comprise a liquid, a viscosifier which imparts a low shear rate viscosity to the fluids of at least 10,000 centipoise, an aphron-generating surfactant, and aphrons. Stable aphron-containing fluids are obtained by increasing the low shear rate viscosity (LSRV) of the fluid to at least 10,000 centipoise, preferably at least 20,000 centipoise, and most preferably to at least 50,000 centipoise. Since the stability of the aphrons is enhanced as the LSRV increases, a LSRV of over a hundred thousand centipoise may be desired. The aphrons are obtained by incorporating (1) an aphron-generating surfactant into the fluid and thereafter generating the aphrons in the fluid or (2) generating the aphrons in a liquid compatible with the fluid and mixing the aphron-containing fluid with the fluid.

The polymer used to build the base fluid and maintain the fluid while re-circulating should preferably be able to achieve the characteristics of LSRV while also protecting the microbubbles without interfering in the reduction of downhole emulsification of water and oil. The polymers useful in the LSRV fluids may comprise any water-soluble polymer which increases the LSRV of the fluid to produce a fluid exhibiting a high yield stress, shear thinning behavior and does not interfere in the reduction of downhole emulsifications of oil and water while also protecting the microbubbles created by the addition at the appropriate time of the aphron generator and atmospheric pressure. Particularly useful are biopolymers produced by the action of bacteria, fungi, or other microorganisms on a suitable substrate. Exemplary biopolymers are the polysaccharides produced by the action of Xanthomonas compestris bacteria which are known as xanthan gums. See, for example, U.S. Pat. Nos. 4,299,825 and 4,758,356, each incorporated herein by reference. Other biopolymers useful in the fluids are the so-called welan gums produced by fermentation with a microorganism of the genus Alcaligenes, Gellan gums, scleroglucan polysaccharides produced by fungi of the genus sclerotium, and succinoglycan biopolymer. The viscosifying agent in some embodiments may be chosen from the group of carbohydrates such as polysaccharides, cellulosic derivatives, guar or guar derivatives, Xanthan, carrageenan, starch polymers, gums, polyacrylamides, polyacrylates, betaine-based surfactants, viscoelastic surfactants, and/or natural or synthetic clays.

The concentration of the polymer to increase the LSRV of the fluid can be determined by testing. The concentration will be an amount sufficient to impart to the fluid the desired LSRV. In various embodiments, the viscosifier may be Horizon Mud's Master Vis, Tex-Xan, and/or Liquid XC. Generally the fluids will contain a concentration from less than or about 0.25 lb/bbl to about 2.5 lb/bbl or more and preferably from about 0.3 lb/bbl to about 1.5 lb/bbl. In some embodiments, the fluid may include copolymer beads such as Mud Masters' Master Fine Beads and/or Master Coarse Beads. The beads may be on the order of 160-900 microns and have a specific gravity of approximately 1.13 to create a ball-bearing effect inside a cased hole to reduce metal-to-metal friction and break capillary forces.

The water based borehole fluids generally may contain materials well known in the art to provide various characteristics or properties to the fluid. Thus the fluids may contain one or more viscosifiers or suspending agents in addition to the polysaccharide, weighting agents, corrosion inhibitors, soluble salts, biocides, fungicides, seepage loss control additives, bridging agents, deflocculants, lubricity additives, shale control additives, and other additives as desired. In some embodiments, the viscosifier may be Mud Masters' Master Clear Seal-5 and/or Master Clear Seal-5 Plus. The viscosifier may be a pulverized powdery inhibitor/lubricant comprising a blend of polymers, starches, and clays, having a specific gravity of 0.66 to 0.75. The viscosifier may help lower API/HPHT fluid loss, decrease wall cake thickness, retard water hydration on clay, extrude into a formation, and act as a deforming sealer. In some embodiments, a fluid additive may include hydrolyzed glucose syrup, such as is described in U.S. Pat. No. 7,745,378, to Rayborn, Sr., entitled Drilling Fluid Additive Containing Corn Syrup Solids, which is hereby incorporated by reference.

The borehole fluids may contain one or more materials which function as encapsulating or fluid loss control additives to further restrict the entry of liquid from the fluid to the contacted shale. Representative materials known in the art include partially solubilized starch, gelatinized starch, starch derivatives, cellulose derivatives, humic acid salts (lignite salts), lignosulfonates, gums, synthetic water soluble polymers, and mixtures thereof.

The fluids should have a pH in the range from about 7.0 to about 10.5, preferably from 8 to about 10. The pH can be obtained as is well known in the art by the addition of acids and/or bases to the fluid, such as potassium hydroxide, potassium carbonate, sodium hydroxide, sodium carbonate, calcium hydroxide, and mixtures thereof and other bases commonly known in the industry.

Various embodiments of the present invention relate to the preparation and use of aphrons during the wellbore drillout and cleanout phases of hydrocarbon production from subterranean reservoirs. Unlike prior drillout and cleanout fluids, the aphrons described herein are stabilized microbubbles that are formed by the combination of solvent-surfactant blends with an appropriate water-based carrier fluid. In general, surfactants adjust surface tension and can be categorized as emulsifying surfactants and non-emulsifying surfactants. When used in rheology up to LSRV, the surfactants useful to create the aphron microbubbles should be compatible with the other chemicals present in the fluid. An aphron is a uniquely structured microbubble created by combining surfactants and polymers in a fluid. Unlike a conventional foam bubble, each aphron is made up of a core, which is often spherical of an internal phase, usually liquid or gas, encapsulated in a thin shell, which prevents leakage of air from the core, provides a barrier against coalescence with adjacent aphrons, and allows the aphron to survive downhole pressures. Typically, the outer surfactant layer is generally hydrophilic, making the aphrons compatible with surrounding water-based fluids.

In the case of the aphron-containing well cleanout fluids, the aphrons may be generated at the surface before being circulated downhole. One way of creating aphron microbubbles is by exposing the base fluid to air at the surface (i.e., at ambient pressure) and agitating the fluid using conventional fluid-mixing equipment to create an air-water emulsion. The surfactant in the fluid is incorporated to achieve the desired concentration of aphrons and produce the surface tension to contain the aphrons as they are formed. The aphrons when first generated contain a wide size distribution ranging from about 25 μm up to about 200 μm in diameter. To successfully complete the generation, the aphrons should be stabilized in the fluid. This may be achieved by using, for example a high yield stress, shear thinning polymer. This type of polymer may act as a viscosifier as well as a stabilizer.

In some embodiments, a well drillout fluid may comprise water, an aphron generator, and a combination of one or more other surfactants, solvents, and/or other additives (e.g., acid). With respect to the solubilizing agent, e.g. the solvent, particularly an organic solvent, non-restrictive examples are alcohols (e.g. methanol, ethanol, isopropanol, butanol, and the like), glycols (e.g. propylene glycol (MPG), dipropylene glycol (DPG), tripropylene glycol (TPG), ethylene glycol (MEG), diethylene glycol (DEG), and the like), glycol ethers (e.g. ethylene glycol monomethyl ether (EGMME)), ethylene glycol monoethyl ether (EGMEE), ethylene glycol monopropyl ether (EGMPE), ethylene glycol monobutyl ether (EGMBE), ethylene glycol monomethyl ether acetate (EGMMEA), ethylene glycol monoethyl ether acetate (EGMEEA acetate) and the like) and alkyl esters (e.g. methyl formate, ethyl formate, methyl acetate, ethyl acetate, butyl acetate, methyl propionate, ethyl propionate, ethyl butyrate, methyl benzoate, ethyl benzoate, methyl ethyl benzoate, and the like), and combinations thereof.

A solvent is a chemical additive that is soluble in oil and water and may be used to prevent or break up emulsions. A mutual solvent is a chemical additive that is soluble in oil, water, acids (often HCl-based), and other well treatment fluids. Mutual solvents are used to stabilize various oil-water emulsions. Mutual solvents remove organic films leaving them water-wet, thus the risk of emulsions may be reduced. A mutual solvent may be ethylene glycol monobutyl ether, generally known as EGBE or EGMBE. In some embodiments, the aphron-generating surfactant may include EGBE, Methanol, Isopropyl Alcohol, and/or other chemicals or equivalents or derivatives thereof. EGBE is an effective coalescent that improves film integrity. Although some embodiments utilize EGBE, other embodiments may use other solvents, other glycol ether solvent, or other chemicals having low surface tension, miscible with water and other organic liquids, and/or are readily biodegradable.

Aphron formation can be achieved along several routes. In one embodiment, aphrons are obtained by including a mixture of surfactants as aphron-generating agents into a solution containing a viscosifier. Suitable surfactants may be anionic, cationic, amphoteric, or nonionic in nature, or their mixtures. Preferably, the molar ratio is higher than 3 to 1. More preferably, it is higher than 5:1 and most preferably, it is higher than 10:1. Suitable surfactant mixtures may be mixtures of surfactants which are soluble in the described solutions. However, surfactant mixtures may also contain one or more (co-)surfactants which are insoluble in the described solutions.

In some embodiments, the surfactant may be Diethanolamine. Diethanolamine, often abbreviated as DEA or DEOA, is an organic viscous liquid. Diethanolamine is polyfunctional, being a secondary amine and a diol. Like other organic amines, diethanolamine acts as a weak base and is soluble in water. Amides prepared from DEA are often also hydrophilic. DEA is used as a surfactant and a corrosion inhibitor. In various embodiments, the non-emulsifying surfactants used should be compatible with the polymers and surfactants utilized, should not prevent a fluid from achieving LSRV, should yield in form and function to the specific chemistry of each wellbore as determined by the testing process before the base fluid is built, and should not interfere with cleaning of the hole during the re-circulating process.

Increases in vapor pressure due to pressure drops, temperature increases, and cavitation are common in downhole conditions. In various embodiments, the risk of cavitation may be reduced by slowing the rate of addition of the solution down. In various embodiments, a self-priming transfer pump may be utilized to avoid foam out of the pump. In addition, the solution may be pulled from a bottom of the supply tank to maintain the lowest possible head.

In some embodiments, aphrons large enough to be seen without magnification can be observed in the fluid as it flows from the borehole into the surface holding tanks (“pits”) before being recirculated. In some embodiments, the fluid may be passed through a screen before being recirculated. After the fluid passes through the screen or shaker, a sample of the fluid may be taken and run through a centrifuge to remove solid particulate. The sample may then be tested for weight (lbs per gal), viscosity, sand content, and other properties. In addition, the rate of barrels in versus the barrels out may be monitored to detect fluid loss downhole. Upon being recirculated downhole, additional aphrons may be generated provided the concentration of the surfactant is sufficient. It may be desirable to add additional surfactant to the fluid either continuously or intermittently until the desired quantity of aphron microbubbles is produced. In various embodiments, the LSRV mud containing aphrons may be stored and reused at subsequent wellbores.

The quantity of aphrons in the fluid often depends on the density required. Generally, the fluid will contain less than 15% by volume of aphrons. Thus, the density of the circulating fluid can be monitored on the surface and additional surfactant added as necessary to maintain the desired density, if the density is too high, and weight material may be added if the density is too low. The quantity of aphrons in the fluid can be determined by adding a known quantity of a defoamer or other chemical to destabilize the surfactant-containing shells surrounding the aphrons. Measurement of the change in volume of the fluid will indicate the volume % of aphrons in the fluid. In some embodiments, Mud Masters' Z-Foam Out may be used as the defoamer.

If desired, the aphrons can be generated on the surface using the procedures and equipment set forth in the following U.S. patents, incorporated herein by reference: Sebba U.S. Pat. No. 3,900,420 and Michelsen U.S. Pat. No. 5,314,644. The well servicing fluid containing the aphrons can then be continuously circulated through the borehole. The so-called water-soluble polymer present in the fluid to enhance the LSRV of the fluid also helps to stabilize the aphrons, thus helping to prevent their coalescence. In some embodiments, the surfactant may be incorporated into the well servicing fluid by blending, pumping, pouring, and/or injecting. If necessary, air, Nitrogen, or other gas can be incorporated into the fluid to entrain more gas.

The fluid may be initially prepared containing 0.3-1.5 lb/bbl of Xanthan gum biopolymer and 1.5-2 gal/100 bbl of an anionic surfactant. The LSRV may be increased for hole cleaning and to create a resistance to movement into the formation, while the polymer encapsulation helps provide strength for the bubble wall surrounding the aphrons. The surfactant solution enables the aphrons to form, reducing the fluid density.

Typical method for chemical mixing is a recipe of adding gallons of chemical per barrels of fluid pumped, sometimes referred as batch treating. The fluid properties of the wellbore fluid and cleaning fluid may be analyzed, such as resistance, viscosity, annular velocity, and the rheology or Reynolds number along with the effects of each. Understanding the effects of friction reducer dosage optimization and monitoring the fluids continuously helps determine the correct amount of friction reducer needed to effectively overcome the internal friction of the fluids and reduce the circulating pressure required for pumping operations during the job. With the optimum chemical dosing, the flow rates and fluid regime may also be adjusted. A certain flow rate (feet per minute) may be required to maintain a sufficiently turbulent flow through the lateral section of the wellbore.

In horizontal wells, gravity causes debris from the drill out to build up along the lower side or bottom of the wellbore. Removing the debris from a horizontal or other non-vertical well can be difficult. Limited pump rate, eccentricity of the pipe, sharp build rates, high bottom hole temperatures, and oval-shaped wellbores can all contribute to inadequate hole cleaning. Well treatments by circulating fluids that have been specially formulated to remove such debris are often necessary to prevent buildup. In order to achieve debris transport within the range of flow conditions in various drill outs and cleanouts, a minimum level of turbulence at the fluid-debris interface may be required to initiate bedload debris transport. Turbulent flow may be needed to facilitate debris removal and provide the downhole conditions to remove the bedload and effectuate continuous hole cleaning during the drill out and/or cleanout. A subtle change in viscosity may have a direct and significant effect on the flow conditions. Improvements in drill out and/or cleanout efficiency and effectiveness may also be seen when mixing and monitoring the fluids throughout the job. In such a setup, the fluids and chemicals are pumped through the mixing plant and mixed on the fly while monitoring the chemical concentrations and fluid performance parameters.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications, and substitutions without departing from the spirit and scope of the invention.

What is claimed is:

1. A method of treating servicing mud used in downhole operations at a well site where the servicing mud is circulated between above-ground equipment and a cased wellbore, the method comprising:
creating a fluid lightener to add to a servicing fluid comprising:
providing an aqueous base fluid;
adding a viscosifier to the base fluid to achieve low shear rate viscosity;
adding an aphron generator to the viscosified base fluid and agitating to generate aphrons in the viscosified base fluid; and
adding a breaker in an inactive state to the viscosified base fluid to reduce the risk of downhole emulsions by breaking down the aphrons and reducing the viscosity of the viscosified base fluid when activated;
injecting the fluid lightener into the servicing fluid to reduce a fluid density of the servicing fluid for servicing a wellbore; and
activating the breaker break down the aphrons and reducing the viscosity of the viscosified base fluid.

2. The method of claim 1 wherein the breaker is encased in a temporary coating.

3. The method of claim 2, wherein the temporary coating delays the activation of the breaker by preventing an interaction between the breaker and the viscosified base fluid.

4. The method of claim 2, wherein the temporary coating is a water-soluble gelatin.

5. The method of claim 1, wherein the breaker is ammonium persulfate.

6. The method of claim 1, wherein a change in pH activates the breaker.

7. The method of claim 1, wherein the activation of the breaker is temperature dependent.

8. The method of claim 1, wherein the breaker is activated upon encountering a downhole emulsion.

9. A method of treating servicing mud used in downhole drill out operations at a well site where the servicing mud is circulated between above-ground equipment and a cased wellbore, the method comprising:
creating a fluid lightener to add to a servicing fluid comprising:
providing an aqueous base fluid;
adding a viscosifier to the base fluid to achieve low shear rate viscosity;
adding an aphron generator to the viscosified base fluid and agitating to generate aphrons in the viscosified base fluid; and
adding a first non-emulsifying surfactant to the viscosified base fluid;
before injecting the fluid lightener into the servicing fluid and circulating the servicing fluid down a wellbore, performing the following:
testing for an elevated risk of downhole emulsions by adding a test fluid having properties similar to the fluid lightener to a mixture of oil and water having properties calculated to be similar to produced oil and produced water from the wellbore, and adding a second non-emulsifying surfactant to the viscosified base fluid if the testing revealed an elevated risk of downhole emulsions; and/or
adding a delayed activation breaker to the viscosified base fluid; and
injecting the fluid lightener into the servicing fluid and circulating the servicing fluid down the wellbore.

10. The method of claim 9 wherein the delayed activation gel breaker is configured to reduce the viscosity of the viscosified base fluid after a period of time.

11. The method of claim 9 wherein the delayed activation gel breaker is encapsulated in a temporary coating.

12. The method of claim 9 wherein a decrease in the viscosity of the viscosified base fluid causes the first non-emulsifying surfactant to break the aphrons.

13. The method of claim 9 wherein the delayed activation gel breaker is activated upon encountering a downhole emulsion.

14. The method of claim 9 wherein the delayed activation gel breaker is solvent activated.

15. A method of treating servicing mud used in downhole drillout operations at a well site where the servicing mud is circulating between above-ground equipment and a cased wellbore, the method comprising:
creating a fluid lightener comprising an aqueous base fluid, a polymer viscosifier, an aphron generator, and a first non-emulsifying surfactant;
adding a second non-emulsifying surfactant to the fluid lightener if known properties of produced oil and produced water from a wellbore where the fluid lightener will be used or from a different wellbore having similar characteristics as the wellbore indicate an elevated risk of downhole emulsions;
adding the fluid lightener to well servicing mud being used to clean out the wellbore in a subterranean formation; and
wherein one or more of the first non-emulsifying surfactant and the second non-emulsifying surfactant are prevented from breaking the polymer viscosifier prior to being activated.

16. The method of claim 15 and further comprising:
breaking the polymer viscosifier by activing the one or more of the first non-emulsifying surfactant and the second non-emulsifying surfactant.

17. The method of claim 16 wherein the one or more of the first non-emulsifying surfactant and the second non-emulsifying surfactant are time activated.

18. The method of claim 16 wherein the one or more of the first non-emulsifying surfactant and the second non-emulsifying surfactant are solvent activated.

19. The method of claim 15 wherein the one or more of the first non-emulsifying surfactant and the second non-emulsifying surfactant are encapsulated in a delayed release capsule.

20. The method of claim 19 wherein the delayed release capsule is temperature dependent.
